(19) United States
(12) Patent Application Publication
(10) Pub. No.: US 2007/0168465 A1
(43) Pub. Date: Jul. 19, 2007

(54) Web Page Optimization Systems

(76) Inventors: Larry W. Toppenberg, Chandler, AZ (US); Craig J. Wilson, Mesa, AZ (US); Roger A. Hackney, Tempe, AZ (US); Steve Flatbush, Chandler, AZ (US)

Correspondence Address: STONEMAN LAW OFFICES, LTD, 3113 NORTH 3RD STREET, PHOENIX, AZ, 85012, US

(21) Appl. No.: 11/614,020

(22) Filed: Dec. 20, 2006

Related U.S. Application Data
(60) Provisional application No. 60/753,667, filed on Dec. 22, 2005.
(60) Provisional application No. 60/783,673, filed on Mar. 17, 2006.
(60) Provisional application No. 60/800,236, filed on May 12, 2006.

(51) Int. Cl. G06F 15/16; D21F 1/00

(52) U.S. Cl. 709/218

(57) ABSTRACT

This invention relates to providing a system for improved web page generation and display. More particularly this invention relates to providing a system for dynamically creating web pages on demand, which are can be indexed by Internet-based search engine indexing programs, from contents stored in one or more databases. Further, index rankings created from the dynamically created pages are optimized using random, but contextually appropriate text replacement, within the web page URL link references and web-page content, and source code ordering.

### CROSS-REFERENCE TO RELATED APPLICATION

The present application is related to and claims priority from prior provisional application Ser. No. 60/753,667, filed Dec. 22, 2005, entitled “WEB PAGE OPTIMIZATION SYSTEMS”, prior provisional application Ser. No. 60/783,673, filed Mar. 17, 2006, entitled “WEB PAGE OPTIMIZATION SYSTEMS”, and prior provisional application Ser. No. 60/800,236, filed May 12, 2006, entitled “WEB PAGE OPTIMIZATION SYSTEMS, the contents of each of which are incorporated herein by this reference and are not admitted to be prior art with respect to the present invention by the mention in this cross-reference section.

### BACKGROUND

This invention relates to providing a system for improved web page generation and display. More particularly this invention relates to providing a system for creating multiple web sites, each having unique, dynamic web pages that can be indexed by Internet-based search engine indexing programs, from content stored in one database. Further, index rankings created from the dynamically created pages are optimized by: contextually appropriate, automatically generated text in anchor text on landing pages, page titles, headings, body text, alt tags and meta-tags; automatic replacement of variables within static web-page content; and source code ordering.

Typically, search engine indexing programs (e.g., spiders) work very well to index web sites with static HTML pages. They do not do well with dynamically generated web sites/web pages. The indexing programs are sophisticated enough to ignore the database query strings embedded in a uniform resource locator which are necessary to retrieve the desired information and create a dynamic web page for a user. These query strings represent variable content to the spider and therefore are not considered valid for indexing.

Thus, a great need exists for a system capable of effectively automating creation of dynamic web pages with variable content that are indexable by spiders.

### OBJECTS AND FEATURES OF THE INVENTION

A primary object and feature of the present invention is to provide a system for creating, on demand, search engine optimized web pages from database content that can be indexed by search engine indexing programs.

It is a further object and feature of the present invention to provide such a system that optimizes search engine index rankings of web pages created on-demand through contextually appropriate random replacement of terms within the content of each web page.

It is a further object and feature of the present invention to provide such a system that supports automated creation of multiple search engine optimized web sites and related web pages using a single set of application source code.

It is a further object and feature of the present invention to provide such a system that supports on-demand creation of multiple web sites and related web pages from essentially one content database, without creating duplicate web pages across multiple sites.

It is a further object and feature of the present invention to provide such a system that supports generating of spider-indexable universal resource locators with imbedded database query arguments.

It is a further object and feature of the present invention to provide such a system that accumulates web page requests and related information associated with each real property.

It is a further object and feature of the present invention to provide such a system that supports automatically controlling spider-indexing of generated web pages.

It is a further object and feature of the present invention to provide such a system that orders the generated web page source code in a manner that further optimizes index rankings of web pages created on-demand.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides an Internet web-based method relating to providing program services, by at least one web-services provider, to at least one plurality of web-site operators of respectively at least one web site each, comprising the steps of: uploading, by such at least one web-services provider, content of at least one database, having information useful to each of such plurality of such web-site operators; receiving, by such at least one web-services provider, web-page content display parameters, relating to such at least one web site, from such at least one web-site operator of such plurality of such web-site operators; computer-generating, on demand, using such received web-page content display parameters, at least one web page containing at least some of such uploaded content for at least one web-site operator of such plurality of such web site operators; computer-generating, on demand, at least one uniform resource locator relating to such at least one web page; and wherein such at least one uniform resource locator comprises at least one web-search term relevant to such at least one web page; computer-generating, on demand, at least one anchor text relating to such at least one uniform resource locator relating to such at least one web page; wherein such at least one anchor text comprises such at least one web-search term relevant to such at least one web page; and wherein such at least one uniform resource locator is indexable by at least one Internet-based-indexing computer program. Moreover, it provides such an internet web-based method wherein at least some of such uploaded content represents real properties offered for sale. Additionally, it provides such a Internet web-based method wherein at least some of such uploaded content represents real properties offered for rent. Also, it provides such a Internet web-based method further comprising the steps of: receiving, by such at least one web-services provider, web-page static content from each of such plurality of such web-site operators; wherein such web-page static content contains at least one replaceable term; creating, by at least one web-services provider, at least one web-search keyword list on behalf of each of such plurality of such web-site operators; and wherein such at least one web-search keyword list comprises such at least one web-search term; replacing, on demand, such at least one replaceable term, with such at least one web-search term; wherein such at least one web-search term is selected from such at least one web-search keyword list. In addition, it provides such a Internet web-based method further comprising the step of arranging web-page source code order relating to such at least one plurality of computer-generated web-pages for search-engine-optimizing indexing by such at least one Internet-based indexing program. And, it provides such a Internet web-based method wherein such computer-generating steps for each such web page of such plurality of web pages are performed by exactly one set of computer programming logic. Further, it provides such a Internet web-based method comprising the steps of: preventing indexing, by such at least one Internet-based indexing program, of such at least one computer-generated web page before associating such web-page static content such at least one computer-generated web page; associating such web-page static content with such at least one computer-generated web page; and permitting indexing, by such at least one Internet-based indexing program, of such at least one computer-generated web page after associating web-page static content with such at least one computer-generated web page; wherein such at least one computer-generated web page, is indexed by such at least one Internet-based-indexing computer program, as unique. Even further, it provides such a Internet web-based method further comprising the steps of: determining, automatically, such content of each such web page of such plurality of web pages to be generated; wherein such determining is based on at least one domain name portion of such at least one uniform resource locator relating to such at least one web page; selecting such at least one web-search term such at least one web-search keyword list; inserting, programmatically, such selected at least one web-search term as at least one meta-tag into each such web page of such plurality of web pages; inserting, programmatically, such selected at least one web-search term into at least one web page heading relating to each such web page of such plurality of web pages; inserting, programmatically, such selected at least one web-search term into at least one page title relating to each such web page of such plurality of web pages; and inserting, programmatically, such selected at least one web-search term as at least one alt tag into each such web page of such plurality of web pages; wherein such selected at least one web-search term is relevant to such content of each such web page of such plurality of web pages; and wherein such at least one web-search term is selected based on its selection frequency. Moreover, it provides such a Internet web-based method further comprising the steps of: offering such program services to at least one web-site operator of such plurality of web-site operators; performing such program services by such at least one web-services provider on behalf of such at least one web-site operator of such plurality of web-site operators; receiving payment for such program services, by such at least one web-services provider from such at least one web-site operator of such plurality of web-site operators. Additionally, it provides such a Internet web-based method wherein at least some of such uploaded content represents real properties offered for rent. Also, it provides such an Internet web-based method wherein at least some of such uploaded content represents real properties offered exclusively. Further, it provides such an Internet web-based method wherein at least some of such web-page content display parameters are useable to define a hierarchy of themed content. Still further, it provides that such web-page content display parameters wherein such hierarchy of themed content comprises a hierarchy of categories of real estate listings. In addition, it provides such an Internet web-based method further comprising the steps of: in exchange for a received link, providing a link for a web page associated with a particular one of such at least one web site, wherein such provided link is different from a previously provided link for the same web-site. Also, it provides that such provided link is provided randomly from a list of links. And, it provides that such provided link is provided according to an assigned selection weighting. Also, it provides such an Internet web-based method further comprises the steps of providing text information along with such provided link wherein such provided text information is different from previously provided text information.

In accordance with another preferred embodiment hereof, this invention provides a computer system, relating to computer generation of at least one plurality of web pages within at least one plurality of web sites on behalf of at least one plurality of web-site operators comprising: first computer processor means for receiving data-based information useful to each of such plurality of such web-site operators; first computer database storage means for storing such received data-based information in at least one first database; first computer interface means for receiving web-page-content display parameters, relating to such at least one web site of such plurality of such web sites; second computer database means for storing such received web-page-content display parameters in at least one second database; second computer processor means for generating, on demand, using such received web-page-content display parameters, at least one web page containing at least some of such received data-based information; third computer processor means for generating, on demand, at least one least one uniform resource locator relating to such at least one web page; wherein such at least one uniform resource locator comprises at least one first web-search term relevant to such received data-based information; and fourth computer processor means for generating, on demand, at least one anchor text relating to such at least one uniform resource locator relating to such at least one web page; wherein such at least one anchor text comprises such at least one first web-search term relevant to such at least one web page; and wherein such at least one uniform resource locator is indexable by at least one Internet-based-indexing program. Also, it provides such a computer system wherein at least some of such received data-based information represents real properties offered for sale. In addition, it provides such a computer system wherein at least some of such received data-based information represents real properties offered for rent. And, it provides such a computer system further comprising: second computer interface means for receiving web-page static content from at least one web-site operator of such plurality of such web-site operators; wherein such web-page static content contains at least one replaceable term; third computer interface means for receiving at least one web-search keyword list on behalf of each of such plurality of such web-site operators; wherein such at least one web-search keyword list comprises at least one web-search term; fifth computer processor means for replacing, on demand, such at least one replaceable term, with such at least one web-search term; and wherein such at least one web-search term is selected from such at least one web-search keyword list. Further, it provides such a computer system further comprising: sixth computer processor means for preventing indexing, by such at least one Internet-based indexing program, of such at least one computer-generated web page before associating such web-page static content such at least one computer-generated web page; seventh computer processor means for associating such web-page static content with such at least one computer-generated web page; and eighth computer processor means for permitting indexing, by such at least one Internet-based indexing program, of such at least one computer-generated web page after associating web-page static content with such at least one computer-generated web page; wherein such at least one computer-generated web page, is indexed by such at least one Internet-based-indexing computer program, as unique. Even further, it provides such a computer system further comprising: ninth computer processor means for determining, automatically, such content of each such web page of such plurality of web pages to be generated; wherein such determining is based on at least one domain name portion of such at least one uniform resource locator relating to such at least one web page; tenth computer processor means for selecting such at least one web-search term from such at least one web-search keyword list; eleventh computer processor means for inserting, automatically, such selected at least one web-search term as at least one meta-tag into each such web page of such plurality of web pages; twelfth computer processor means for inserting, programmatically, such selected at least one web-search term into at least one web page heading relating to each such web page of such plurality of web pages; thirteenth computer processor means for inserting, programmatically, such selected at least one web-search term into at least one page title relating to each such web page of such plurality of web pages; and fourteenth computer processor means for inserting, programmatically, such selected at least one web-search term as at least one alt tag into each such web page of such plurality of web pages; wherein such selected at least one web-search term is relevant to such content of each such web page of such plurality of web pages; and wherein such at least one web-search term is selected based on its selection frequency. Moreover, it provides such a computer system wherein at least some of such received data-based information represents real properties offered for rent.

In accordance with another preferred embodiment hereof, this invention provides a computer program system, relating to computer generation of at least one plurality of web pages within at least one plurality of web sites on behalf of at least one plurality of web-site operators comprising: at least one first computer processor adapted to receive data-based information useful to each of such plurality of such web-site operators; at least one first computer database storage adapted to store such received data-based information in at least one first database; at least one first computer interface adapted to receive web-page-content display parameters, relating to such at least one web site of such plurality of such web sites; at least one second computer database adapted to store such received web-page-content display parameters in at least one second database; at least one second computer processor adapted to generate, on demand, using such received web-page-content display parameters, at least one web page containing at least some of such received data-based information; at least one third computer processor adapted to generate, on demand, at least one least one uniform resource locator relating to such at least one web page; wherein such at least one uniform resource locator comprises at least one first web-search term relevant to such received data-based information; and at least one fourth computer processor adapted to generate, on demand, at least one anchor text relating to such at least one uniform resource locator relating to such at least one web page; wherein such at least one anchor text comprises such at least one web-search term relevant to such at least one web page; and wherein such at least one uniform resource locator is indexable by at least one Internet-based-indexing program. Additionally, it provides such a computer program system wherein at least some of such received data-based information represents real properties offered for sale. Also, it provides such a computer program system wherein at least some of such received data-based information represents real properties offered for rent. In addition, it provides such a computer program system further comprising: at least one second computer interface adapted to for receive web-page static content from at least one web-site operator of such plurality of such web-site operators; wherein such web-page static content contains at least one replaceable term; third computer interface adapted to receive at least one specific web-search keyword list on behalf of each of such plurality of such web-site operators; wherein such web-search keyword list comprises at least one web-search term; at least one fifth computer processor adapted to replace, on demand, such at least one replaceable term, with such at least one web-search term; and wherein such at least one web-search term is selected from such at least one web-search keyword list. And, it provides such a computer system further comprising: at least one sixth computer processor adapted to determine, automatically, such content of each such web page of such plurality of web pages to be generated; wherein such determining is based on at least one domain name portion of such at least one uniform resource locator relating to such at least one web page; at least one seventh computer processor adapted to select such at least one web-search term from such at least one web-search keyword list; at least one eighth computer processor adapted to insert, automatically, such selected at least one web-search term as at least one meta-tag into each such web page of such plurality of web pages; at least one ninth computer processor adapted to insert, programmatically, such selected at least one web-search term into at least one web page heading relating to each such web page of such plurality of web pages; at least one tenth computer processor adapted to insert, programmatically, such selected at least one web-search term into at least one page title relating to each such web page of such plurality of web pages; and at least one eleventh computer processor adapted to insert, programmatically, such selected at least one web-search term as at least one alt tag into each such web page of such plurality of web pages; wherein such selected at least one web-search term is relevant to such content of each such web page of such plurality of web pages; and wherein such at least one web-search term is selected based on its selection frequency. Further, it provides such a computer program system further comprising: at least one twelfth computer processor adapted to prevent indexing, by such at least one Internet-based indexing program, of such at least one computer-generated web page before associating such web-page static content such at least one computer-generated web page; at least one thirteenth computer processor adapted to associate such web-page static content with such at least one computer-generated web page; and at least one fourteenth computer processor adapted to permit indexing, by such at least one Internet-based indexing program, of such at least one computer-generated web page after associating web-page static content with such at least one computer-generated web page; wherein such at least one computer-generated web page, is indexed by such at least one Internet-based-indexing computer program, as unique. Even further, it provides such a computer program system wherein at least some of such received data-based information represents real properties offered for rent.

In accordance with another preferred embodiment hereof, this invention provides a computer system, relating to automated generation of at least one uniform resource locator, relating to at least one data record stored in at least one database, on behalf of at least one web-site operator of at least one plurality of web-site operators comprising: computer processing means for receiving at least one data record comprising information useful to at least one of such plurality of such web-site operators; computer database means for storing such at least one received data record in at least one database; computer interface means for receiving at least one web-site operator specific web-search keyword list; wherein such at least one web-site operator specific web-search keyword list comprises at least one web-search term; at least one computer processor means for substantially automatically constructing at least one uniform resource locator, referring to at least one web page for displaying such at least one stored data record; wherein such constructed at least one uniform resource locator comprises at least one randomly selected web-search term relating to each such at least one web page; at least one computer processor means for substantially automatically constructing at least one anchor text relating to such constructed at least one uniform resource locator relating to such at least one web page; wherein such at least one anchor text comprises such at least one web-search term relevant to such at least one web page; and wherein such at least one uniform resource locator is indexable by at least one Internet-based-indexing computer program. Moreover, it provides such a computer system further comprising: at least one computer processor means for receiving at least one web-page request based on such at least one constructed uniform resource locator; and computer processor means, for generating at least one set of web-page source code, relating to such at least one received uniform resource locator, usable by at least one web browser for displaying such at least one web page having at least one data record retrieved from at least one data base; wherein such at least one set of web-page source code order is arranged for search-engine-optimizing indexing by such at least one Internet-based indexing program. Additionally, it provides such a computer system further comprising: computer interface means for receiving web-page content display parameters; computer database means for storing such web-page content display parameters, relating to each such at least one web site, from each of such plurality of such web-site operators; computer interface means for receiving web-page static content from such at least one web-site operator; computer database means for storing such web-page static content in at least one database wherein such web-page static content contains at least one replaceable term; computer processor means for replacing, on demand, such at least one replaceable term, with such at least one web-search term; wherein such at least one web-search term is randomly selected from such at least one web-site operator specific keyword list; and computer processor means, for generating at least one set of source code, related to such at least one received uniform resource locator, usable by at least one web browser for displaying at least one web page having at least some static content retrieved from at least one data base.

In accordance with another preferred embodiment hereof, this invention provides a computer system, relating to automatic generation of at least one static uniform resource locator referencing at least one dynamic web page on behalf of at least one web-site operator comprising: first computer processor means for receiving dynamic web-page content useful to such at least one web-site operator; first computer database storage means for storing such received dynamic web-page content in at least one first database; second computer processor means for selecting at least some dynamic web-page content; third computer processor means for selecting at least one keyword relating to such selected at least some dynamic web-page content; and fourth computer processor means for constructing such at least one static uniform resource locator referencing such selected at least some dynamic web-page content; and wherein such constructed at least one static uniform resource locator comprises such at least one keyword relating to such selected at least some dynamic web-page content; and wherein such constructed at least one static uniform resource locator contains at least one database search argument relating to selecting such selected at least some dynamic web-page content from such at least one first database; fifth computer processor means for constructing at least one anchor text relating to such constructed at least one static uniform resource locator; wherein such at least one anchor text comprises such at least one keyword relating to such selected at least some dynamic web-page content; and wherein such constructed at least one static uniform resource locator is indexable by at least one Internet-based-indexing program. Also, it provides such a method wherein such second computer processor means for selecting at least some dynamic web-page content comprises: sixth computer processor means for receiving web-page-content display parameters for such at least one web site from such at least one web-site operator; second computer database means for storing such received web-page-content display parameters in at least one second database; seventh computer processor means for receiving keywords related to such at least one web site on behalf of such at least one web-site operator; third computer database means for storing such received keywords in at least one third database; and eighth computer processor means for selecting, using such stored display parameters, such at least some dynamic web-page content. In addition, it provides such a method further comprising ninth computer processor means for receiving at least one dynamic web-page request, using such constructed at least one static uniform resource locator, for such selected dynamic web-page content; and tenth computer processor means for generating requested such at least one dynamic web-page from such selected at least some web-page content.

In accordance with another preferred embodiment hereof, this invention provides a method relating to search engine optimization relating to computer generation of at least one plurality of dynamic web pages within at least one plurality of web sites on behalf of at least one plurality of web-site operators comprising the steps of: identifying web-content indexing methods of web-content indexing entities; adapting web site computer generation methods to optimize web-content indexing results for such computer generated web pages within such at least one plurality of web sites; computer generating at least one static uniform resource locator referencing such at least one dynamic web page of such plurality of dynamic web pages; wherein such at least one static uniform resource locator comprises at least one database query argument for selecting at least some dynamic content; wherein such at least one static uniform resource locator comprises at least one indexable keyword relating to such selected dynamic content; computer generating such at least one dynamic web page; wherein such at least one dynamic web page comprises such selected dynamic content; wherein such at least one dynamic web page comprises static content; wherein such static content contains at least one replaceable term; identifying at least one plurality of keywords using latent semantic analysis of such static content; selecting, at least on keyword of such identified plurality of keywords; replacing such at least one replaceable term with selected such at least one keyword; re-phrasing at least one anchor text referring to such at least one static uniform resource locator on selected such at least one dynamic web page using such at least one keyword; wherein such at least one keyword is relevant to such dynamic content, and wherein such at least one keyword is relevant to such static content; arranging source code relating to generated such at least one dynamic web page for search-engine-optimizing indexing by such at least one Internet-based indexing program; inserting, programmatically, at least one meta-tag into generated such at least one dynamic web page; wherein such at least one meta-tag comprises at least one keyword, wherein such at least one keyword is relevant to such dynamic content of generated such at least one dynamic web page, wherein such at least one keyword is relevant to such static content of generated such at least one dynamic web page; inserting, programmatically, at least one web-page heading into generated such at least one dynamic web page; wherein such at least one web-page heading comprises at least one keyword, wherein such at least one keyword is relevant to such dynamic content of generated such at least one dynamic web page, wherein such at least one keyword is relevant to such static content of generated such at least one dynamic web page; inserting, programmatically, at least one web-page title into generated such at least one dynamic web page; wherein such at least one web-page title comprises at least one keyword, wherein such at least one keyword is relevant to such dynamic content of generated such at least one dynamic web page, wherein such at least one keyword is relevant to such static content of generated such at least one dynamic web page; inserting, programmatically, at least one alt tag into generated such at least one dynamic web page; wherein such at least one web-page title comprises at least one keyword, wherein such at least one keyword is relevant to such dynamic content of generated such at least one dynamic web page, wherein such at least one keyword is relevant to such static content of generated such at least one dynamic web page; preventing indexing, by such at least one Internet-based indexing program, of such at least one dynamic web page before associating descriptive content provided by such at least one web-site operator with such at least one static uniform resource locator referencing such at least one dynamic web page; associating such descriptive content provided by such at least one web-site operator with such at least one static uniform resource locator referencing such at least one dynamic web page; and permitting indexing, by such at least one Internet-based indexing program, of such at least one dynamic web page after associating descriptive content provided by such at least one web-site operator with such at least one static uniform resource locator referencing such at least one dynamic web page.

In accordance with another preferred embodiment hereof, this invention provides an Internet web-based method relating to providing program services, by at least one web-services provider, to at least one plurality of web-site operators of respectively at least one web site each, comprising the steps of: uploading, by such at least one web-services provider, content of at least one database, having information useful to each of such plurality of such web-site operators; receiving, by such at least one web-services provider, web-page content display parameters, relating to such at least one web site, from such at least one web-site operator of such plurality of such web-site operators; computer-generating, on demand, using such received web-page content display parameters, at least one web page containing at least some of such uploaded content for at least one web-site operator of such plurality of such web site operators; computer-generating, on demand, at least one uniform resource locator relating to such at least one web page; and wherein such at least one uniform resource locator comprises at least one web-search term relevant to such at least one web page; wherein such at least one uniform resource locator is indexable by at least one Internet-based-indexing computer program.

In accordance with another preferred embodiment hereof, this invention provides a computer system, relating to computer generation of at least one plurality of web pages within at least one plurality of web sites on behalf of at least one plurality of web-site operators comprising: first computer processor means for receiving data-based information useful to each of such plurality of such web-site operators; first computer database storage means for storing such received data-based information in at least one first database; first computer interface means for receiving web-page-content display parameters, relating to such at least one web site of such plurality of such web sites; second computer database means for storing such received web-page-content display parameters in at least one second database; second computer processor means for generating, on demand, using such received web-page-content display parameters, at least one web page containing at least some of such received data-based information; third computer processor means for generating, on demand, at least one least one uniform resource locator relating to such at least one web page; wherein such at least one uniform resource locator comprises at least one first web-search term relevant to such received data-based information; and wherein such at least one uniform resource locator is indexable by at least one Internet-based-indexing program.

In accordance with a preferred embodiment hereof, this invention provides an Internet web-based method relating to providing program services, by at least one web-services provider, to at least one plurality of web-site operators of respectively at least one web site each, comprising the steps of: uploading, by such at least one web-services provider, content of at least one database, having information useful to each of such plurality of such web-site operators; receiving, by such at least one web-services provider, web-page content display parameters, relating to such at least one web site, from such at least one web-site operator of such plurality of such web-site operators; computer-generating, on demand, using such received web-page content display parameters, at least one web page containing at least some of such uploaded content for at least one web-site operator of such plurality of such web site operators; computer-generating, on demand, at least one uniform resource locator relating to such at least one web page; and wherein such at least one uniform resource locator comprises at least one web-search term relevant to such at least one web page; computer-generating, on demand, at least one anchor text relating to such at least one uniform resource locator relating to such at least one web page; wherein such at least one anchor text comprises such at least one web-search term relevant to such at least one web page; and wherein such at least one uniform resource locator is indexable by at least one Internet-based-indexing computer program. Moreover, it provides such an internet web-based method wherein at least some of such uploaded content represents real properties offered for sale. Additionally, it provides such a Internet web-based method wherein at least some of such uploaded content represents real properties offered for rent. Also, it provides such a Internet web-based method further comprising the steps of: receiving, by such at least one web-services provider, web-page static content from each of such plurality of such web-site operators; wherein such web-page static content contains at least one replaceable term; creating, by at least one web-services provider, at least one web-search keyword list on behalf of each of such plurality of such web-site operators; and wherein such at least one web-search keyword list comprises such at least one web-search term; replacing, on demand, such at least one replaceable term, with such at least one web-search term; wherein such at least one web-search term is selected from such at least one web-search keyword list. In addition, it provides such a Internet web-based method further comprising the step of arranging web-page source code order relating to such at least one plurality of computer-generated web-pages for search-engine-optimizing indexing by such at least one Internet-based indexing program. And, it provides such a Internet web-based method wherein such computer-generating steps for each such web page of such plurality of web pages are performed by exactly one set of computer programming logic. Further, it provides such a Internet web-based method comprising the steps of: preventing indexing, by such at least one Internet-based indexing program, of such at least one computer-generated web page before associating such web-page static content with such at least one computer-generated web page; associating such web-page static content with such at least one computer-generated web page; and permitting indexing, by such at least one Internet-based indexing program, of such at least one computer-generated web page after associating web-page static content with such at least one computer-generated web page; wherein such at least one computer-generated web page, is indexed by such at least one Internet-based-indexing computer program, as unique. Even further, it provides such a Internet web-based method further comprising the steps of: determining, automatically, such content of each such web page of such plurality of web pages to be generated; wherein such determining is based on at least one domain name portion of such at least one uniform resource locator relating to such at least one web page; selecting such at least one web-search term such at least one web-search keyword list; inserting, programmatically, such selected at least one web-search term as at least one meta-tag into each such web page of such plurality of web pages; inserting, programmatically, such selected at least one web-search term into at least one web page heading relating to each such web page of such plurality of web pages; inserting, programmatically, such selected at least one web-search term into at least one page title relating to each such web page of such plurality of web pages; and inserting, programmatically, such selected at least one web-search term as at least one alt tag into each such web page of such plurality of web pages; wherein such selected at least one web-search term is relevant to such content of each such web page of such plurality of web pages; and wherein such at least one web-search term is selected based on its selection frequency. Moreover, it provides such a Internet web-based method further comprising the steps of: offering such program services to at least one web-site operator of such plurality of web-site operators; performing such program services by such at least one web-services provider on behalf of such at least one web-site operator of such plurality of web-site operators; receiving payment for such program services, by such at least one web-services provider from such at least one web-site operator of such plurality of web-site operators. Additionally, it provides such a Internet web-based method wherein at least some of such uploaded content represents real properties offered for rent. Also, it provides such a Internet web-based method wherein at least some of such uploaded content represents real properties offered exclusively. In addition, it provides such a Internet web-based method wherein at least some of such web-page content display parameters are useable to define a hierarchy of themed content. And, it provides such a Internet web-based method wherein such hierarchy of themed content comprises a hierarchy of categories of real estate listings. Further, it provides such a Internet web-based method further comprising the steps of: in exchange for a received link, providing a link for a web page associated with a particular one of such at least one web site; wherein such provided link is different from a previously provided link for the same web site. Even further, it provides such a Internet web-based method wherein such provided link is provided randomly from a list of links. Moreover, it provides such a Internet web-based method wherein such provided link is provided according to an assigned selection weighting. Additionally, it provides such a Internet web-based method further comprising the step of: providing text information along with such provided link; wherein such provided text information is different from previously provided text information.

In accordance with another preferred embodiment hereof, this invention provides a computer program system, relating to computer generation of at least one plurality of web pages within at least one plurality of web sites on behalf of at least one plurality of web-site operators comprising: at least one first computer processor adapted to receive data-based information useful to each of such plurality of such web-site operators; at least one first computer database storage adapted to store such received data-based information in at least one first database; at least one first computer interface adapted to receive web-page-content display parameters, relating to such at least one web site of such plurality of such web sites; at least one second computer database adapted to store such received web-page-content display parameters in at least one second database; at least one second computer processor adapted to generate, on demand, using such received web-page-content display parameters, at least one web page containing at least some of such received data-based information; at least one third computer processor adapted to generate, on demand, at least one least one uniform resource locator relating to such at least one web page; wherein such at least one uniform resource locator comprises at least one first web-search term relevant to such received data-based information; and at least one fourth computer processor adapted to generate, on demand, at least one anchor text relating to such at least one uniform resource locator relating to such at least one web page; wherein such at least one anchor text comprises such at least one web-search term relevant to such at least one web page; and wherein such at least one uniform resource locator is indexable by at least one Internet-based-indexing program. Also, it provides such a computer program system wherein at least some of such received data-based information represents real properties offered for sale. In addition, it provides such a computer program system wherein at least some of such received data-based information represents real properties offered for rent. And, it provides such a computer program system further comprising: at least one second computer interface adapted to for receive web-page static content from at least one web-site operator of such plurality of such web-site operators; wherein such web-page static content contains at least one replaceable term; third computer interface adapted to receive at least one specific web-search keyword list on behalf of each of such plurality of such web-site operators; wherein such web-search keyword list comprises at least one web-search term; at least one fifth computer processor adapted to replace, on demand, such at least one replaceable term, with such at least one web-search term; and wherein such at least one web-search term is selected from such at least one web-search keyword list. Further, it provides such a computer program system further comprising: at least one sixth computer processor adapted to determine, automatically, such content of each such web page of such plurality of web pages to be generated; wherein such determining is based on at least one domain name portion of such at least one uniform resource locator relating to such at least one web page; at least one seventh computer processor adapted to select such at least one web-search term from such at least one web-search keyword list; at least one eighth computer processor adapted to insert, automatically, such selected at least one web-search term as at least one meta-tag into each such web page of such plurality of web pages; at least one ninth computer processor adapted to insert, programmatically, such selected at least one web-search term into at least one web page heading relating to each such web page of such plurality of web pages; at least one tenth computer processor adapted to insert, programmatically, such selected at least one web-search term into at least one page title relating to each such web page of such plurality of web pages; and at least one eleventh computer processor adapted to insert, programmatically, such selected at least one web-search term as at least one alt tag into each such web page of such plurality of web pages; wherein such selected at least one web-search term is relevant to such content of each such web page of such plurality of web pages; and wherein such at least one web-search term is selected based on its selection frequency. Even further, it provides such a computer program system further comprising: at least one twelfth computer processor adapted to prevent indexing, by such at least one Internet-based indexing program, of such at least one computer-generated web page before associating such web-page static content such at least one computer-generated web page; at least one thirteenth computer processor adapted to associate such web-page static content with such at least one computer-generated web page; and at least one fourteenth computer processor adapted to permit indexing, by such at least one Internet-based indexing program, of such at least one computer-generated web page after associating web-page static content with such at least one computer-generated web page; wherein such at least one computer-generated web page, is indexed by such at least one Internet-based-indexing computer program, as unique. Moreover, it provides such a computer program system wherein at least some of such received data-based information represents real properties offered for rent. Additionally, it provides such a computer program system further comprising: at least one fifteenth computer processor adapted to provide, for a received link, a web page associated with a particular one of such plurality of web sites; wherein such provided link is different from a previously provided link for the same web site. Also, it provides such a computer program system wherein such provided link is provided randomly from a list of links. In addition, it provides such a computer program system wherein such provided link is provided according to an assigned selection weighting. And, it provides such a computer program system further comprising: at least one sixteenth computer processor adapted to provide text information along with such provided link; wherein such provided text information is different from previously provided text information.

In accordance with another preferred embodiment hereof, this invention provides a computer system, relating to automated generation of at least one uniform resource locator, relating to at least one data record stored in at least one database, on behalf of at least one web-site operator of at least one plurality of web-site operators comprising: at least one first computer processor adapted to receive at least one data record comprising information useful to at least one of such plurality of such web-site operators; at least one first database adapted to store such at least one received data record in at least one database; at least one first computer interface adapted to receive at least one web-site operator specific web-search keyword list; wherein such at least one web-site operator specific web-search keyword list comprises at least one web-search term; at least one second computer processor adapted to substantially automatically construct at least one uniform resource locator, referring to at least one web page for displaying such at least one stored data record; wherein such constructed at least one uniform resource locator comprises at least one randomly selected web-search term relating to each such at least one web page; at least one third computer processor adapted to substantially automatically construct at least one anchor text relating to such constructed at least one uniform resource locator relating to such at least one web page; wherein such at least one anchor text comprises such at least one web-search term relevant to such at least one web page; and wherein such at least one uniform resource locator is indexable by at least one Internet-based-indexing computer program. Further, it provides such a computer system further comprising: at least one fourth computer processor adapted to receive at least one web-page request based on such at least one constructed uniform resource locator; and at least one fifth computer processor adapted to generate at least one set of web-page source code, relating to such at least one received uniform resource locator, usable by at least one web browser for displaying such at least one web page having at least one data record retrieved from at least one data base; wherein such at least one set of web-page source code order is arranged for search-engine-optimizing indexing by such at least one Internet-based indexing program. Even further, it provides such a computer system further comprising: at least one second computer interface adapted to receive web-page content display parameters; at least one second database adapted to store such web-page content display parameters, relating to each such at least one web site, from each of such plurality of such web-site operators; at least one second computer interface adapted to receive web-page static content from such at least one web-site operator; at least one third database adapted to store such web-page static content in at least one database; wherein such web-page static content contains at least one replaceable term; at least one sixth computer processor adapted to replace, on demand, such at least one replaceable term, with such at least one web-search term; wherein such at least one web-search term is randomly selected from such at least one web-site operator specific keyword list; and at least one seventh computer processor adapted to generate at least one set of source code, related to such at least one received uniform resource locator, usable by at least one web browser for displaying at least one web page having at least some static content retrieved from at least one data base.

In accordance with another preferred embodiment hereof, this invention provides a computer system, relating to automatic generation of at least one static uniform resource locator referencing at least one dynamic web page on behalf of at least one web-site operator comprising: at least one first computer processor adapted to receive dynamic web-page content useful to such at least one web-site operator; at least one first database adapted to store such received dynamic web-page content in at least one first database; at least one second computer processor adapted to select at least some dynamic web-page content; at least one third computer processor adapted to select at least one keyword relating to such selected at least some dynamic web-page content; and at least one fourth computer processor adapted to construct such at least one static uniform resource locator referencing such selected at least some dynamic web-page content; and wherein such constructed at least one static uniform resource locator comprises such at least one keyword relating to such selected at least some dynamic web-page content; and wherein such constructed at least one static uniform resource locator contains at least one database search argument relating to selecting such selected at least some dynamic web-page content from such at least one first database; at least one fifth computer processor adapted to construct at least one anchor text relating to such constructed at least one static uniform resource locator; wherein such at least one anchor text comprises such at least one keyword relating to such selected at least some dynamic web-page content; and wherein such constructed at least one static uniform resource locator is indexable by at least one Internet-based-indexing program. Even further, it provides such a computer system wherein such second computer processor adapted to select at least some dynamic web-page content comprises: at least one sixth computer processor adapted to receive web-page-content display parameters for such at least one web site from such at least one web-site operator; at least one second database adapted to store such received web-page-content display parameters in at least one second database; at least one seventh computer processor adapted to receive keywords related to such at least one web site on behalf of such at least one web-site operator; at least one third database adapted to store such received keywords in at least one third database; and at least one eighth computer processor adapted to select, using such stored display parameters, such at least some dynamic web-page content. Even further, it provides such a computer system further comprising at least one ninth computer processor adapted to receive at least one dynamic web-page request, using such constructed at least one static uniform resource locator, for such selected dynamic web-page content; and at least one tenth computer processor adapted generate requested such at least one dynamic web-page from such selected at least some web-page content.

In accordance with another preferred embodiment hereof, this invention provides a method relating to search engine optimization relating to computer generation of at least one plurality of dynamic web pages within at least one plurality of web sites on behalf of at least one plurality of web-site operators comprising the steps of: identifying web-content indexing methods of web-content indexing entities; adapting web site computer generation methods to optimize web-content indexing results for such computer generated web pages within such at least one plurality of web sites; computer generating at least one static uniform resource locator referencing such at least one dynamic web page of such plurality of dynamic web pages; wherein such at least one static uniform resource locator comprises at least one database query argument for selecting at least some dynamic content; wherein such at least one static uniform resource locator comprises at least one indexable keyword relating to such selected dynamic content; computer generating such at least one dynamic web page; wherein such at least one dynamic web page comprises such selected dynamic content; wherein such at least one dynamic web page comprises static content; wherein such static content contains at least one replaceable term; identifying at least one plurality of keywords using latent semantic analysis of such static content; selecting, at least on keyword of such identified plurality of keywords; replacing such at least one replaceable term with selected such at least one keyword; re-phrasing at least one anchor text referring to such at least one static uniform resource locator on selected such at least one dynamic web page using such at least one keyword; wherein such at least one keyword is relevant to such dynamic content, and wherein such at least one keyword is relevant to such static content; arranging source code relating to generated such at least one dynamic web page for search-engine-optimizing indexing by such at least one Internet-based indexing program; inserting, programmatically, at least one meta-tag into generated such at least one dynamic web page; wherein such at least one meta-tag comprises at least one keyword, wherein such at least one keyword is relevant to such dynamic content of generated such at least one dynamic web page, wherein such at least one keyword is relevant to such static content of generated such at least one dynamic web page; inserting, programmatically, at least one web-page heading into generated such at least one dynamic web page; wherein such at least one web-page heading comprises at least one keyword, wherein such at least one keyword is relevant to such dynamic content of generated such at least one dynamic web page, wherein such at least one keyword is relevant to such static content of generated such at least one dynamic web page; inserting, programmatically, at least one web-page title into generated such at least one dynamic web page; wherein such at least one web-page title comprises at least one keyword, wherein such at least one keyword is relevant to such dynamic content of generated such at least one dynamic web page, wherein such at least one keyword is relevant to such static content of generated such at least one dynamic web page; inserting, programmatically, at least one alt tag into generated such at least one dynamic web page; wherein such at least one web-page title comprises at least one keyword, wherein such at least one keyword is relevant to such dynamic content of generated such at least one dynamic web page, wherein such at least one keyword is relevant to such static content of generated such at least one dynamic web page; preventing indexing, by such at least one Internet-based indexing program, of such at least one dynamic web page before associating descriptive content provided by such at least one web-site operator with such at least one static uniform resource locator referencing such at least one dynamic web page; associating such descriptive content provided by such at least one web-site operator with such at least one static uniform resource locator referencing such at least one dynamic web page; and permitting indexing, by such at least one Internet-based indexing program, of such at least one dynamic web page after associating descriptive content provided by such at least one web-site operator with such at least one static uniform resource locator referencing such at least one dynamic web page.

In accordance with another preferred embodiment hereof, this invention provides an Internet web-based method relating to providing program services, by at least one web-services provider, to at least one plurality of web-site operators of respectively at least one web site each, comprising the steps of: uploading, by such at least one web-services provider, content of at least one database, having information useful to each of such plurality of such web-site operators; receiving, by such at least one web-services provider, web-page content display parameters, relating to such at least one web site, from such at least one web-site operator of such plurality of such web-site operators; computer-generating, on demand, using such received web-page content display parameters, at least one web page containing at least some of such uploaded content for at least one web-site operator of such plurality of such web site operators; computer-generating, on demand, at least one uniform resource locator relating to such at least one web page; and wherein such at least one uniform resource locator comprises at least one web-search term relevant to such at least one web page; wherein such at least one uniform resource locator is indexable by at least one Internet-based-indexing computer program.

In accordance with another preferred embodiment hereof, this invention provides a computer system, relating to computer generation of at least one plurality of web pages within at least one plurality of web sites on behalf of at least one plurality of web-site operators comprising: at least one first computer processor adapted to receive data-based information useful to each of such plurality of such web-site operators; at least one first computer database adapted to store such received data-based information in at least one first database; at least one first computer interface adapted to receive web-page-content display parameters, relating to such at least one web site of such plurality of such web sites; at least one second computer database adapted to store such received web-page-content display parameters in at least one second database; at least one second computer processor adapted to generate, on demand, using such received web-page-content display parameters, at least one web page containing at least some of such received data-based information; at least one third computer processor adapted to generate, on demand, at least one least one uniform resource locator relating to such at least one web page; wherein such at least one uniform resource locator comprises at least one first web-search term relevant to such received data-based information; and wherein such at least one uniform resource locator is indexable by at least one Internet-based-indexing program.

### BRIEF DESCRIPTION OF THE DRAWINGS

FIG. 1 shows an overview schematic of the web-page generation business method, its processes and their relationships relating to dynamic web page generation on behalf of realtors according to a preferred embodiment of the present invention.

FIG. 2 shows an overview schematic of set up and maintenance process relating to establishment of a dynamic web page generation web site on behalf of a realtor according to a preferred embodiment of the present invention.

FIG. 3 shows an overview schematic of dynamic web page generation system according to a preferred embodiment of the present invention.

FIG. 4 shows an overview schematic of dynamic web page generation process flow when a web page is requested through a realtor's home page according to a preferred embodiment of the present invention.

FIG. 5 shows an overview schematic of dynamic web page generation process flow when a web page is requested from a search engine results page according to a preferred embodiment of the present invention.

FIGS. 6(a) and 6(b) show overview schematics of a link exchange process flow according to a preferred embodiment of the present invention.

FIG. 7 shows a sample of a generated realtor web page for a city according to a preferred embodiment of the present invention.

FIG. 8 shows a sample of the html code template used to generate the required html source code according to a preferred embodiment of the present invention.

FIG. 9 shows a sample of the source code and web-page content stored in the dynamic content database according to a preferred embodiment of the present invention.

FIG. 10 shows a sample of the fully generated source code and web-page content according to a preferred embodiment of the present invention.

FIG. 11 shows a sample of a generated web page for real estate listings for a category of properties within a city according to a preferred embodiment of the present invention.

FIG. 12 shows a sample of the source code template used to generate a web page of real estate listings for a category of properties within a city according to a preferred embodiment of the present invention.

FIG. 13 shows a sample of text with text identified as replaceable for use on a generated web page for real estate listings for a category of properties within a city according to a preferred embodiment of the present invention.

FIG. 14 shows a sample of a generated web page for a real estate property from a category of properties listing within a city according to a preferred embodiment of the present invention.

FIG. 15 shows a sample of the html code template used Web Site Generation System to generate the required html source code for a property detail web page according to a preferred embodiment of the present invention.

FIG. 16 shows a sample of text with identified replaceable text for a generated web page for a real estate property from a category of properties listing within a city according to a preferred embodiment of the present invention

FIG. 17 shows an example of the table selection screen used to select a control table to be updated according a preferred embodiment of the present invention.

FIG. 18 shows an example of the table entry screen for each agency used to select the table to be updated according a preferred embodiment of the present invention.

FIG. 19 shows an example of the table entry screen for entry of table values of a realtor used to select the table to be updated according a preferred embodiment of the present invention.

FIG. 20 shows an example screen used for entry of static HTML used by

FIG. 21 shows an example screen showing the primary database tables used by web site generation system according to a preferred embodiment of the present invention.

FIG. 22 shows a first example screen showing the primary database queries used by web site generation system according to a preferred embodiment of the present invention.

FIG. 23 shows a second example screen showing the primary database queries and stored procedures used by web site generation system according to a preferred embodiment of the present invention.

FIG. 24 shows a third example screen showing the primary database queries and stored procedures used by web site generation system according to a preferred embodiment of the present invention.

FIG. 25 shows a fourth example screen showing the primary database queries and stored procedures used by web site generation system according to a preferred embodiment of the present invention.

FIG. 26 shows examples of generated web page URL's for a realtor's web site with inserted keywords according to a preferred embodiment of the present invention.

FIG. 27 shows an example set-up screen for entering information to set up a landing page library according to a preferred embodiment of the present invention.

FIG. 28 shows an example of a preview screen for previewing the provided landing page library information according to a preferred embodiment of the present invention.

FIG. 29 shows an example screen for inputting information for assigning a landing page library to a particular customer according to a preferred embodiment of the present invention.

FIG. 30 shows an example screen for creating a landing page record according to a preferred embodiment of the present invention.

FIG. 31 shows an example screen for assigning weighting values to a plurality of landing pages according to a preferred embodiment of the present invention.

FIG. 32 shows an example screen for displaying HTML code containing a link along with text describing a landing page which the link is associated with according to a preferred embodiment of the present invention.

### DEFINITIONS AND ACRONYMS

The following terms and acronyms are explained below as background and are used throughout the detailed description:

Alt Attribute (referred to herein as alt tag). Used in HTML documents to specify text that is to be rendered when the element to which it is applied cannot be rendered. In HTML 4.01, the attribute is required for the “img” and area element types. It is optional for the input element type and the deprecated applet element type. Alternative text is especially useful in the following situations:

For people with low bandwidth connections, who may opt not to load graphics,

For people using handheld devices,

For people with disabilities who use assistive technology, such as refreshable Braille displays or screen readers, and

Search engine optimization. Many search engines can only interpret the meaning of objects by analyzing their alt attribute

Cascading Style Sheet (CSS). In computing, Cascading Style Sheets (CSS) is a style sheet language used to describe the presentation of a document written in a markup language. It's most common application is to style web pages written in HTML and XHTML. The CSS specifications are maintained by the World Wide Web Consortium (W3C).

CSS is used by both the authors and readers of web pages to define colors, fonts, layout, and other aspects of document presentation. It is designed primarily to enable the separation of document content (written in HTML or a similar markup language) from document presentation (written in CSS). Multiple style sheets can be imported, and alternative style sheets can be specified so that the user can choose between them. Different styles can be applied depending on the output device being used. For example, the screen version may be quite different from the printed version. This allows authors to tailor the presentation appropriately for each kind of media.

Client-Server. A model of interaction in a distributed system in which a program at one site sends a request to a program at another site and waits for a response. The requesting program is called the “client,” and the program that responds to the request is called the “server.” In the context of the World Wide Web, the client is typically a “Web browser” that runs on a user's computer; the program that responds to Web browser requests at a Web site is commonly referred to as a “Web server.”

Database. One or more large structured sets of persistent data maintained upon a computer system organized and structured according to a software system defining rules for organization as well responding to queries to read, write or modify data as well as provide statistical information regarding the contained data. As used herein for purposes of discussion, a database may be either a single unified system or a distributed system wherein certain database elements are located upon different systems, acting in harmony to appear as one unified database.

Domain Name. The “www.domain.com” portion of the URL is called a “domain name.” The domain name is a unique Internet alphanumeric address that identifies the virtual location of Internet resources related to a particular organization. For example, URLs containing the domain name “www.realtorXYZ.com” might include resources related to a company fictionally named Realtor XYZ.

Domain Name System (DNS). An Internet service that translates domain names (which are alphabetic identifiers) into IP addresses (which are numeric identifiers for machines on a TCP/IP network).

Extensible Markup Language (XML). XML describes a class of data objects known as XML documents and partially describes the behavior of computer programs which process these documents. More specifically, XML is a restricted form of the Standard Generalized Markup Language (also known as SGML). XML documents are made up of storage units defined as entities which in turn comprise either parsed or unparsed data in the form of characters or simply a character. XML is designed and intended to improve the functionality of the Internet by providing more flexible and adaptive forms of information. XML can be used to store any kind of structured information and in such encapsulated form, pass it between different computer systems which would otherwise be unable to communicate.

File Transport Protocol (FTP). The protocol used on the Internet for exchanging files. FTP is most commonly used to download a file from a server using the Internet or to upload a file to a server (e.g., uploading a Web page file to a server).

Hypertext Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other websites and other Web documents (commonly referred to as “hyperlinks”). For more information on HTML, see Ian S. Graham, The HTML Source Book, John Wiley and Sons, Inc., 1995 (ISBN 0471-11894-4).

Hypertext Transport Protocol (HTTP). The standard World Wide Web client-server protocol used for the exchange of information (such as HTML documents and client requests for such documents) between a Web browser and a Web server. HTTP includes a number of different types of messages that can be sent from the client to the server to request different types of server actions. For example, a “GET” message, which has the format GET, causes the server to return the document or file located at the specified Universal Resource Locator (URL).

HTTPS. HTTP over SSL (Secure Sockets Layer) can be best understood as a secure form of HTTP communication. Specifically, SSL is a protocol utilized for the authentication and encryption of HTTP traffic. In operation, the server and client exchange a set of encryption keys that are used to create a unique encryption key used to encrypt all data exchanged during the session.

Internet. A collection of interconnected (public and/or private) networks that are linked together by a set of standard protocols to form a distributed network. While this term is intended to refer to what is now commonly known as the Internet, it is also intended to encompass variations that may be made in the future, including changes and additions to existing standard protocols.

Latent Semantic Analysis (LSA). Latent semantic analysis (LSA) is a technique in natural language processing, in particular in vectorial semantics, invented in 1990 [1] by Scott Deerwester, Susan Dumais, George Furnas, Thomas Landauer, and Richard Harshman. In the context of its application to information retrieval, it is sometimes called latent semantic indexing (LSI). Applications of LSA include the classification of documents, information retrieval, web-site content indexing, etc. LSA is meant to solve two fundamental problems in natural language processing. Synonymy refers to situations in which different writers use different words to describe the same idea. Thus, a person issuing a query in a search engine may use a different word than appears in a document, and may not retrieve the document. In polysemy, the same word can have multiple meanings, so a searcher can get unwanted documents with the alternate meanings.

LAN. A Local Area Network of computer systems, typically within a building or office, permitting networking, the associated sharing of resources and files, such as application software, printers and client information, in an inter-office setting.

Meta-tag. Meta-tags are HTML elements used to provide structured metadata about a web page. Such elements are placed as tags in the head section of an HTML document. The two most common uses of meta-tags on the web are to provide a description and to provide keywords for a webpage. This data may then be used by search engines to generate and display a list of search results matching a given query. Meta-tags such as these have been the focus of a field of marketing research known as search engine optimization (SEO). In the mid to late 1990s, search engines were reliant on meta-tag data to correctly classify a web page.

Microsoft IIS (Internet Information Services) Server. A set of Internet-based services for servers using Microsoft Windows.

Microsoft .net Framework. Commonly known as simply the .NET Framework, is a software development platform created by Microsoft. .NET Framework is a Microsoft technology that allows cross-language development and provides a large standard library. Other competing approaches are cross-platform languages, i.e. Perl, using a cross-platform runtime like the Java Virtual Machine, or compile standard ANSI C to each platform.

Multiple Listing Service (MLS). (Also Multiple Listing System or Multiple Listings Service) A database that allows a broker representing a seller to share information about the property for sale widely with brokers representing potential buyers. The purpose of the MLS is to enable a more efficient marketplace to occur between brokers by distributing information. When a real estate agent is introduced to potential home buyer, the agent can access the MLS system to retrieve information about homes for sale in a geographic area. The MLS permits that agent to view information about homes represented by OTHER brokers. The MLS is an exchange for real estate, just as the New York Stock Exchange and NASDAQ are exchanges for securities, but the MLS it is not an open exchange or a public exchange. Each MLS's is governed by a private entity and the rules are set by that private entity. The MLS typically combines the listings for all available properties that are represented by all brokers that are members of the MLS. Membership in the MLS is generally considered to be essential to the practice of real estate brokerage—a broker that is not a member of the MLS cannot put information into the MLS or access information put in by other brokers. In general, MLS's restrict membership and access to real estate agents who are 1) licensed by the state, and 2) members of the trade association, the National Association of Realtors. In many cases, a local MLS is a company owned and operated by brokers that use it. In some cases, the MLS is owned by the local or state trade association of real estate agents. In most cases, MLS's abide by rules set by the National Association of Realtors (NAR). Currently, in the United States there is no one central MLS. MLS's have city-wide or regional coverage. In 2005, there were approximately 800 MLS's in America, each dedicated to a city or region.

PHP. (The initials come from the earliest version of the program, which was called “Personal Home Page Tools”) A server-side, cross-platform, HTML-embedded scripting language used to create dynamic web pages. PHP is Open Source software.

Search Engine. Program designed to help find information stored on a computer system such as the World Wide Web, or a personal computer. The search engine allows one to ask for content meeting specific criteria (typically those containing a given word or phrase) and retrieves a list of references that match those criteria. Search engines use regularly updated indexes to operate quickly and efficiently. Without further qualification, search engine usually refers to a Web search engine, which searches for information on the public Web. Other kinds of search engine are enterprise search engines, which search on intranets, personal search engines, which search individual personal computers, and mobile search engines.

Search Engine Optimization (SEO). Set of methods aimed at improving the ranking of a website in search engine listings. SEO is primarily concerned with advancing the goals of web sites by improving the number and position of its organic search results for a wide variety of relevant keywords. SEO strategies can increase the number of visitors, and the quality of visitors, where quality means visitors who complete the action the site intends (e.g. purchase, sign up, learn something). Ranking well in the organic search results can provide targeted traffic, potentially at a lower cost. Site owners may choose to optimize their sites for organic search.

Session ID. In the case of transport protocols which do not implement a formal session layer sessions are maintained by a higher level program using a method defined in the data being exchanged. For example, an HTTP exchange between a browser and a remote host may include an HTTP cookie which identifies state, such as a unique session ID, information about the user's preferences or authorization level.

Spider. See Web Crawler below.

Structured Query Language (SQL). SQL is a standard language used to communicate with relational database management systems (such as Oracle, Sybase, Microsoft SQL Server, Access, etc.) for the purpose of performing tasks such as data insertion, deletion, update, and general query for the return of data.

Simple Object Access Protocol (SOAP). SOAP is a lightweight XML/HTTP-based protocol for the exchange of information in a decentralized distributed platform-independent environment. Fundamentally, SOAP consists of three parts. The first is an envelope that defines a framework for describing what is contained in the message and how it should be processed. The second is a set of encoding rules for expressing instances of application-defined data types. The third is a normalized convention for representing remote procedure calls and responses.

Transmission Control Protocol/Internet Protocol (TCP/IP). A standard Internet protocol (or set of protocols) which specifies how two computers exchange data over the Internet. TCP/IP handles issues such as packetization, packet addressing, and handshaking and error correction. For more information on TCP/IP, see Volumes I, II and III of Corner and Stevens, Internetworking with TCP/IP, Prentice Hall, Inc., ISBNs 0-13-468505-9 (vol. I), 0-13-125527-4 (vol. II), and 0-13-474222-2 (vol. III).

Uniform Resource Locator (URL). A unique address which fully specifies the location of a file or other resource on the Internet. The general format of a URL is protocol://machine address:port/path/filename. The port specification is optional, and, if not entered by the user, the Web browser defaults to the standard port for whatever service is specified as the protocol. For example, if HTTP is specified as the protocol, the Web browser will use the HTTP default port. The machine address in this example is the domain name for the computer or device on which the file is located.

USB. Universal Serial Bus. USB provides a serial bus standard for connecting devices, usually to a computer, but it also is in use on other devices such as set-top boxes, game consoles. USB can connect peripherals such as mice, keyboards, gamepads and joysticks, scanners, digital cameras, printers, hard disks, and networking components.

WAN. A Wide Area Network, such as the Internet.

Web Crawler (also known as a web spider or ant). A program which browses the World Wide Web in a methodical, automated manner. Web crawlers are mainly used to create a copy of all the visited pages for later processing by a search engine, which indexes the downloaded pages to provide fast searches. Crawlers can also be used for automating maintenance tasks on a web site, such as checking links or validating HTML code. Also, crawlers can be used to gather specific types of information from Web pages, such as harvesting e-mail addresses (usually for spam). A web crawler is one type of bot, or software agent. In general, it starts with a list of URLs to visit. As it visits these URLs, it identifies all the hyperlinks in the page and adds them to the list of URLs to visit, recursively browsing the Web according to a set of policies.

World Wide Web (“Web”). Used herein to refer generally to both (1) a distributed collection of interlinked, user-viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the Hypertext Transfer Protocol (HTTP), and the electronic pages are encoded using the Hypertext Markup Language (HTML). However, the terms “World Wide Web” and “Web” are intended to encompass future markup languages and transport protocols that may be used in place of or in addition to the Hypertext Markup Language (HTML) and the Hypertext Transfer Protocol (HTTP).

### DETAILED DESCRIPTION OF THE BEST MODES AND PREFERRED EMBODIMENTS OF THE INVENTION

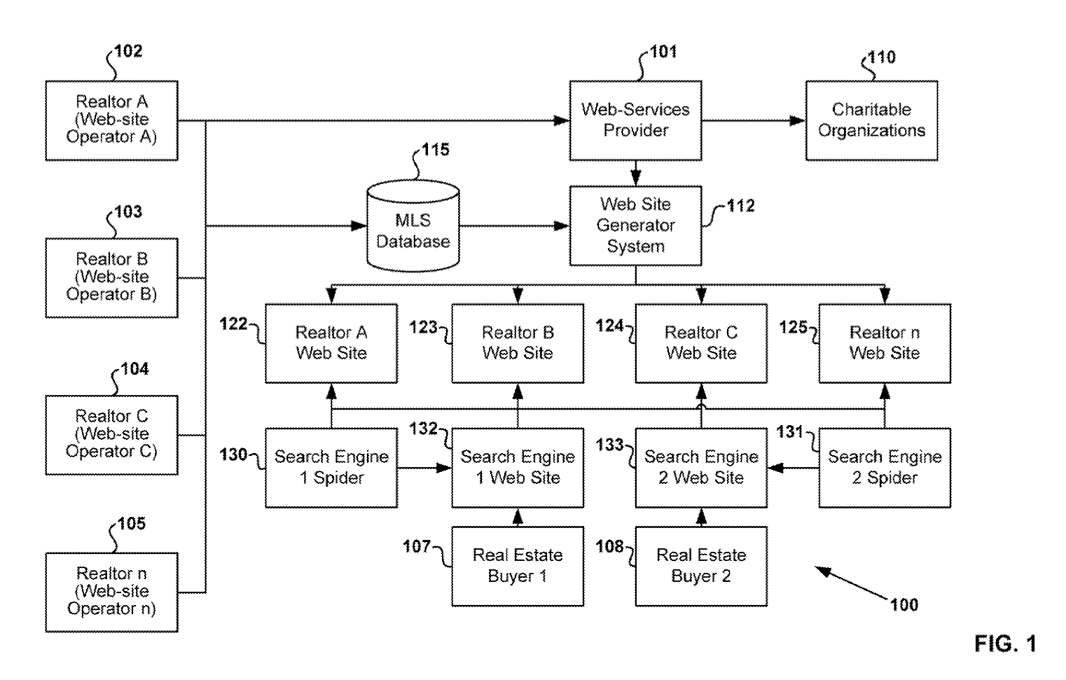

Referring to FIG. 1, an overview schematic of a Web-page Generation system 100, its processes and their relationship relating to dynamic web page generation on behalf of realtors according to a preferred embodiment of the present invention, preferably Realtor A 102 (representative of any number of realtors, including, as depicted, Realtor B 103, Realtor C 104 and Realtor n 105) completes an agreement with Web-Services Provider 101 to provide web-site development services including the use of Web Site Generation System 112 relating to the creation and maintenance of Realtor A Web Site 122 (representative of any number of web sites for realtors, including, as depicted, Realtor B Web Site 123, Realtor C Web Site 124 and Realtor n Web Site 125) (at least herein embodying offering such program services to at least one web-site operator of such plurality of web-site operators). Preferably, Realtor A 102 will, as part of the agreement to provide web-site development services, provide Web-Services Provider 101 permission to access the MLS Database 115 on behalf of Realtor A 102 for the purpose of displaying real property information on Realtor A Web Site 122. Preferably, web-site development services provided by Web-Services Provider 101 includes automated creation of an search-engine-indexable web site which is search-engine-optimized to achieve the desired index rankings, such as Realtor A Web Site 122, from content, parameters and web-page source code stored in Master Tables Database 218, Static Page Content Database 217 and MLS Copy Database 215 (at least herein embodying performing such program services by such at least one web-services provider on behalf of such at least one web-site operator of such plurality of web-site operators). Preferably, the real property information displayed includes real properties for sale and real properties for rent/lease (at least herein embodying wherein at least some of such uploaded content represents real properties offered for sale; and at least herein embodying wherein at least some of such uploaded content represents real properties offered for rent). Preferably, Web-Services Provider 101 receives payment from Realtor A 102 in return for providing web-site development services on behalf of Realtor A 102 (at least herein embodying receiving payment for such program services, by such at least one web-services provider from such at least one web-site operator of such plurality of web-site operators). Preferably, Web-Services Provider 101 contributes income in excess of costs to selected Charitable Organizations 110.

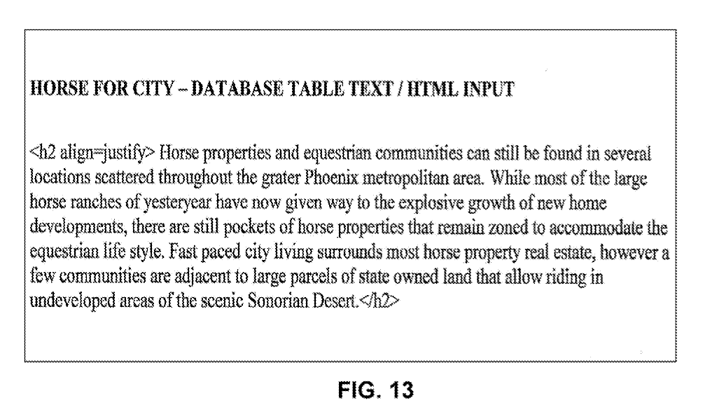

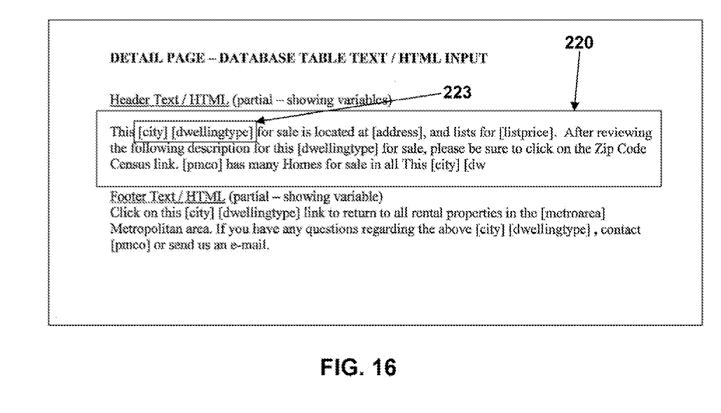

Preferably, Realtor A 102 provides static information to Web-Services Provider 101. Preferably, this information is in the form of text, graphics (logos, etc.) and images which are used on some or all web pages, such as page header and footer text (See FIG. 13 and FIG. 16). Preferably, Realtor A 102 may also provide any personal (custom) HTML pages for the site for such web pages as “About Us”. Preferably, textual information provided by Realtor A 102 includes replacement variables which permit Web-Site Generator System 112 to automatically replace the variable with Keywords 224 relevant to content of the automatically generated web page. Keywords 224 are preferably selected and used to assist in optimizing indexing ranking results of selected web pages by spiders used by search engine providers.

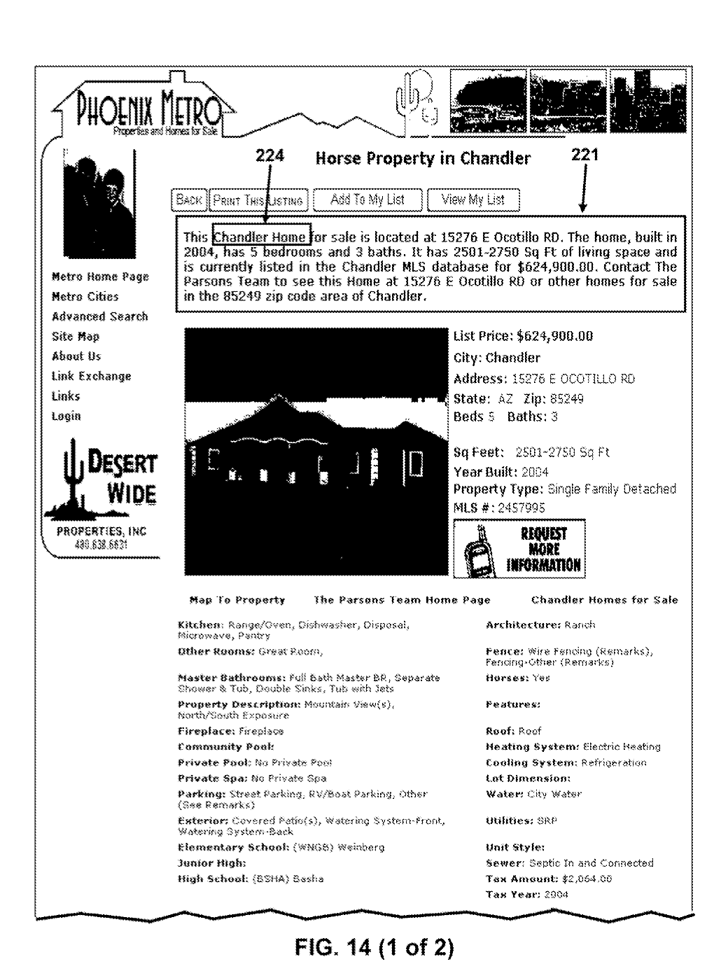

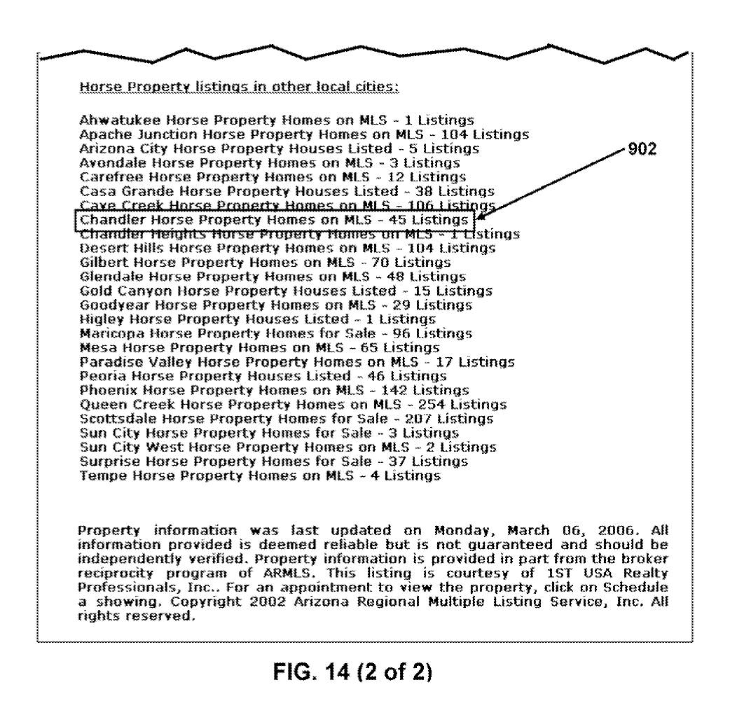

Preferably, Realtor A 102 also provides parametric information about preferred geographic areas (such as suburb names or “east valley”), and preferred property types (such as “horse properties”, “view properties”, etc.). Preferably, Web-Services Provider 101 utilizes this information to automatically select the properties from MLS Copy Database 215 for display on Realtor A Web Site 122. Preferably, each automatically generated web page providing information about a property offered for sale or rent/lease (See FIG. 14) is search-engine-indexable by spiders operated by one or more search engine providers such as Yahoo.com and Google.com.

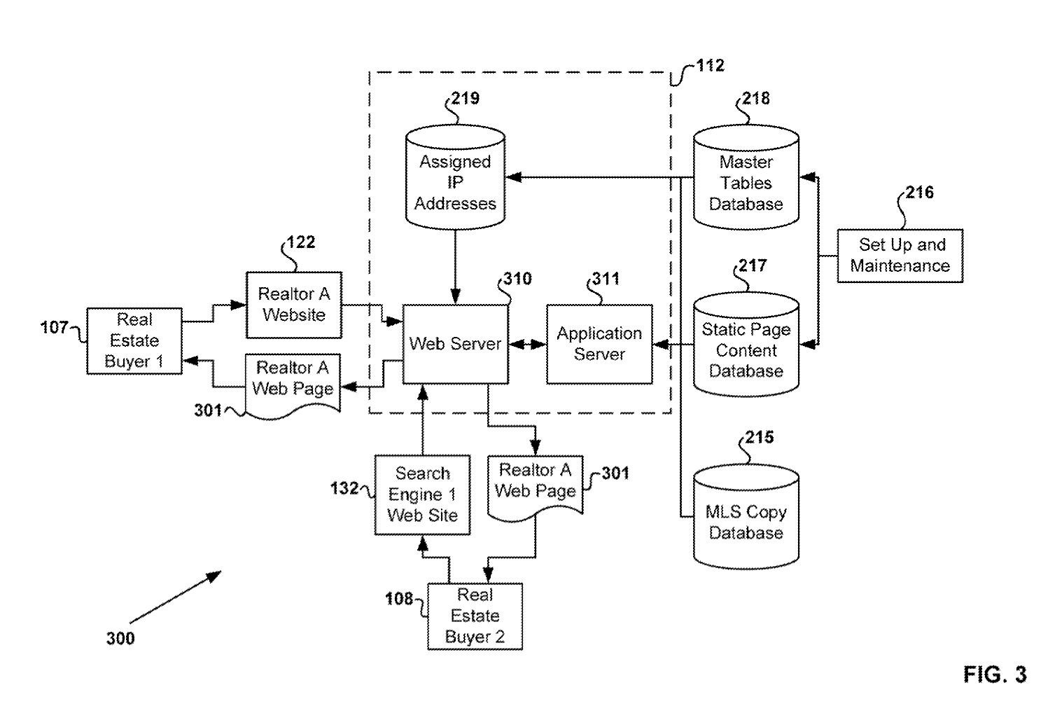

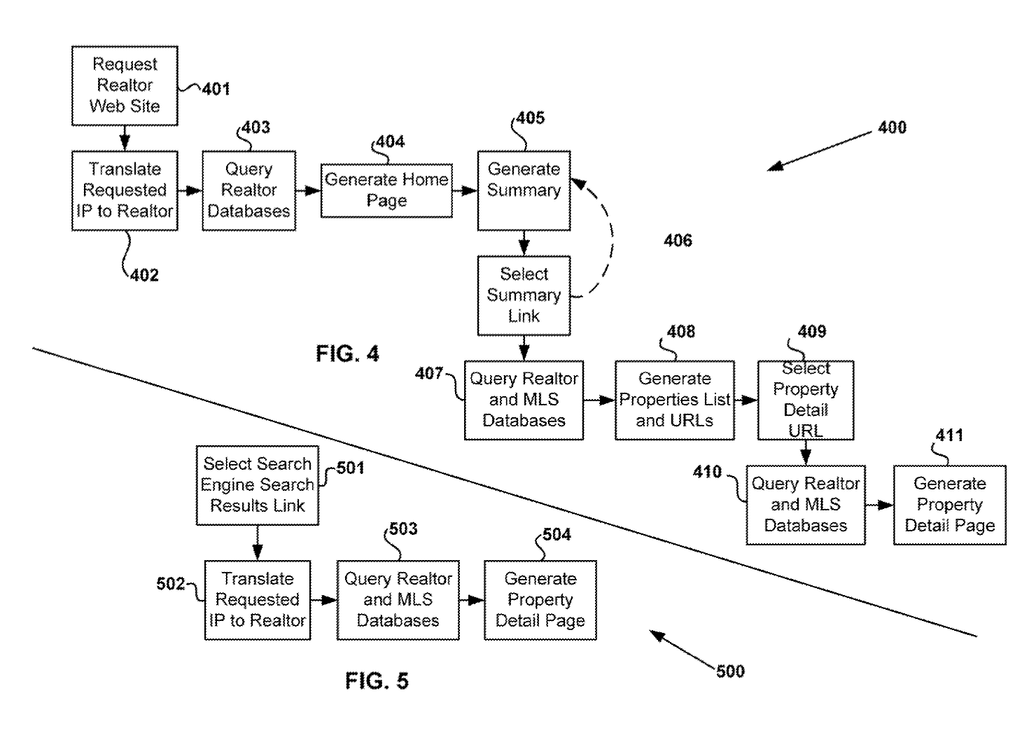

According to a preferred embodiment of the present invention, automated creation of a search-engine-indexable web site, such as Realtor A Web Site 122, is accomplished by Web-Site Generator System 112. Preferably, Web-Site Generator System 112 generates, on request, all appropriate static and dynamic pages for Realtor A Web Site 122 using various methods (described below with respect to FIG. 3, FIG. 4 and FIG. 5) from selected content from MLS Copy Database 215, Static Page Content Database 217 and Master Tables Database 218. Preferably, the same set of application programs and methods comprising Web Site Generation System 112 is used for all generated web pages within each generated web site, such as Realtor A Web Site 122 (representative of any number of realtor's web sites, including, as depicted, Realtor B Web Site 123, Realtor C Web Site 124 and Realtor n Web Site 125). Preferably, each generated web site requires unique content, provided by Realtor A 102 (representative of any number of realtors, including, as depicted, Realtor B 103, Realtor C 104 and Realtor n 105), as described above to ensure uniqueness and to make it available to be indexed by spiders. Preferably, the robots meta-tag is automatically set to “NOINDEX” if the geographic or specialty segments web page is being generated without any human created content. Preferably, if human created content is present and will be incorporated in the generated web page the robots meta-tag value will not be set to “NOINDEX”. (An example of this usage is “<META NAME=“ROBOTS” CONTENT=“NOINDEX, NOFOLLOW”>”). This method ensures generated web page uniqueness by preventing spiders from indexing web pages containing solely automatically generated content without preventing use of the generated web pages by human users.

Preferably, Search Engine 1 Spider 130 (representative of any number of search engine spiders, including, as depicted, Search Engine 2 Spider 131) finds Realtor A Web Site 122 (representative of any number of realtor's web sites, including, as depicted, Realtor B Web Site 123, Realtor C Web Site 124 and Realtor n Web Site 125) and indexes each appropriate web page contained within Realtor A Web Site 122 by associating the URL of each appropriate web page with desired keywords representing the subject matter of the page. The indexing results of Search Engine 1 Spider 130 are then made available through Search Engine 1 Web Site 132 (representative of any number of search engine web sites, including, as depicted, Search Engine 2 Web Site 133) to Real Estate Buyer 1 107 (representative of any number of real estate buyers, including, as depicted, Real Estate Buyer 2 108) when Real Estate Buyer 1 107 accesses Search Engine 1 Web Site 132 and initiates a search using one or keywords associated with the subject matter of a page contained within Realtor A Web Site 122. Real Estate Buyer 1 107 may then select a link returned by Search Engine 1 Web Site 132 and then view the desired web page preferably generated by Web Site Generation System 112. Thus Real Estate Buyer 1 107 may search for, and find, real properties which meet his/her criteria in the same manner he/she would search for any other information on the Internet even though the information is stored in a database and each web page is dynamic and generated on request.

According to a preferred embodiment of the present invention, real estate listings from sources other than MLS Database 115 can be used. For example, Realtor A can provide some or all of their “exclusive” real estate listings. Exclusive real estate listing information can either be in the same format as an MLS listing or structured differently. Preferably, the exclusive real estate listings will only be available on web pages associated with a particular realtor (Realtor A in this example) since these real estate listings are exclusive to a realtor. They can be displayed in a separate category, e.g., “Exclusive Listings of Realtor A”, or displayed together with MLS listings. Preferably, if the exclusive real estate listings are placed together with MLS listings, the exclusive real estate listings will be identified as being exclusive listings.

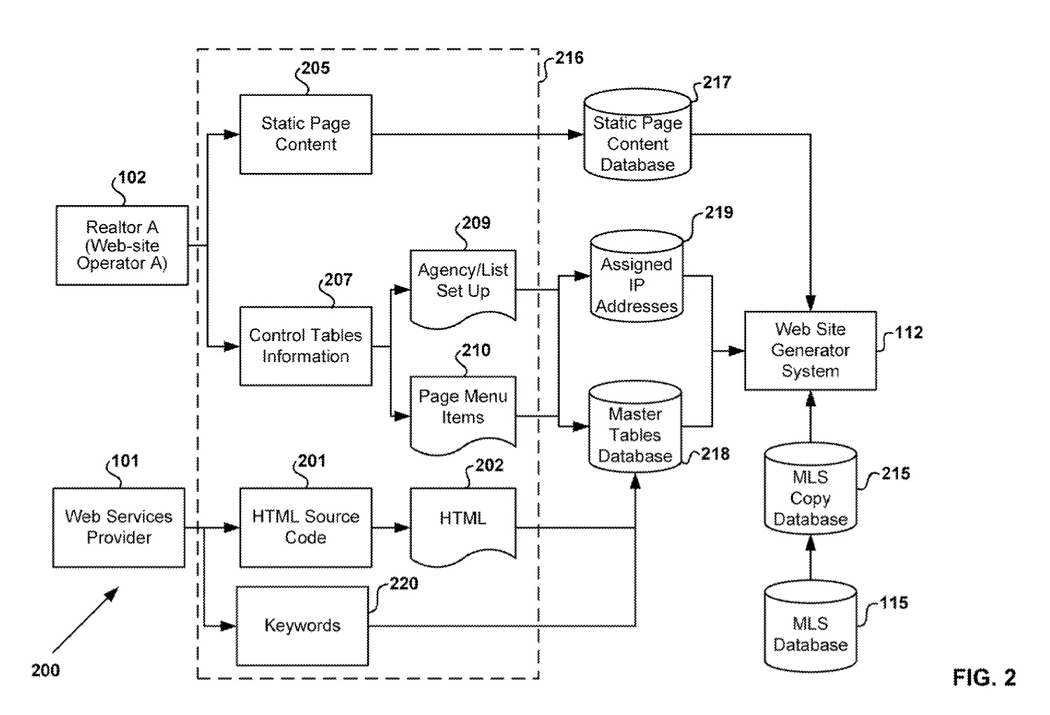

Referring to FIG. 2, which shows an overview schematic of set up and maintenance process 200 relating to establishment of a dynamic web page generation web site on behalf of Realtor A 102 according to a preferred embodiment of the present invention, preferably each night the content of MLS Database 115 is downloaded to MLS Copy Database 215 which is accessible by Web Site Generation System 112 (at least herein embodying uploading, by such at least one web-services provider, content of at least one database, having information useful to each of such plurality of such web-site operators). Preferably, content uploaded is selected by geographic areas or other selection criteria, such as view properties or luxury homes or some other criteria based on information contained in MLS Database selected by Realtor A 102. Preferably, Web Services Provider 101 will only upload content if Realtor A 102 is a member of the local MLS organization and is therefore authorized to utilize MLS Database 115.

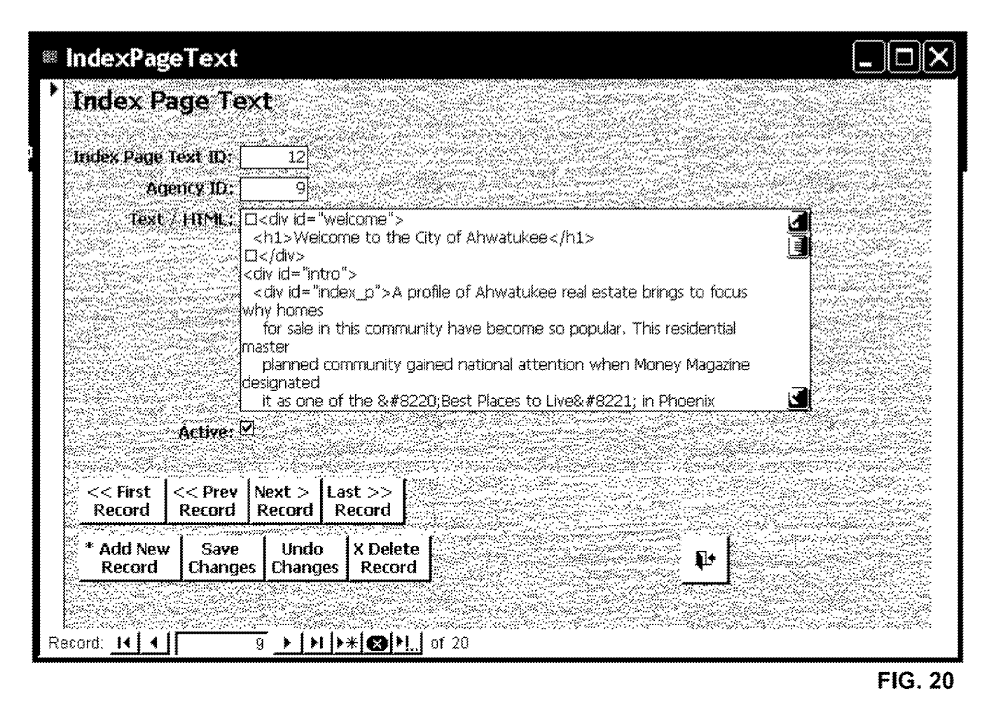

Preferably, in process Static Page Content 205, Realtor A 102 provides either completed static page HTML or information sufficient for Web Services Provider 101 to complete required static page HTML. Preferably, Web Services Provider 101 provides detailed instructions for completing required static HTML pages to Realtor A 102 (Refer to Appendix A—Website Template Requirements and Design Instructions and Appendix E—Link Building Functions). Typically static HTML pages are used for “About Us”, “Contact Us” and similar personalized pages. Additionally, Web Services Provider 101 requires Realtor A 102 to provide Header Graphic, Navigation Menu Top Image, web page backgrounds image, Navigation Menu Bottom Image, and Navigation Menu Middle Background (at least herein embodying receiving, by such at least one web-services provider, web-page static content from each of such plurality of such web-site operators). Preferably, required information and content provided by Realtor A 102 is entered and stored in Static Page Content Database 217 at completion of process Static Page Content 205 preferably using Data Mgt System 216 (See FIG. 20 for an example input screen) (at least herein embodying receiving, by such at least one web-services provider, web-page content display parameters, relating to such at least one web site, from such at least one web-site operator of such plurality of such web-site operators).

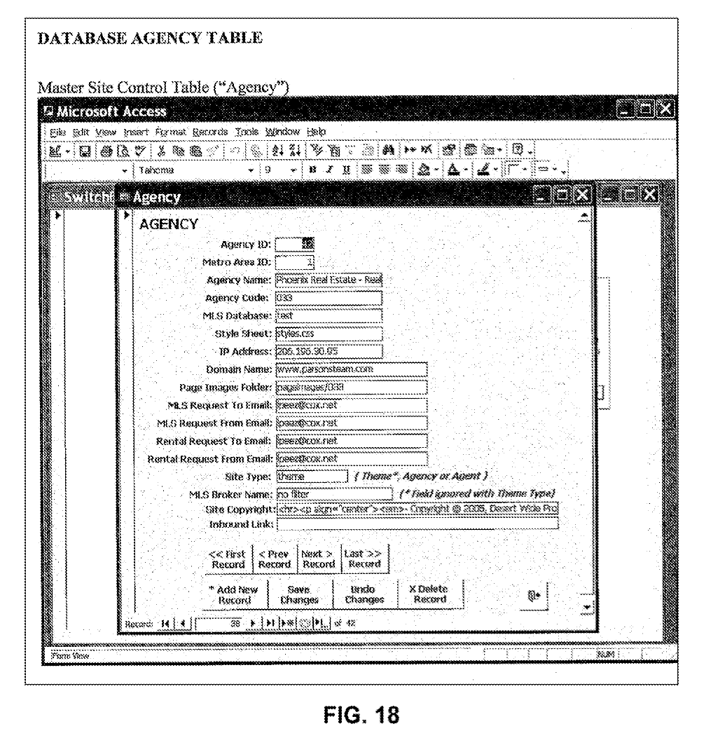

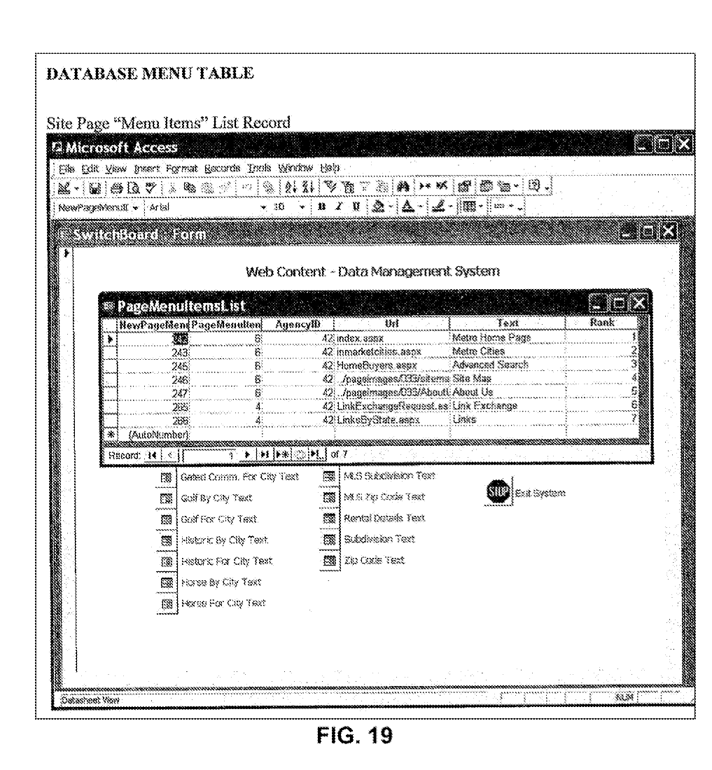

Preferably, Web Services Provider 101 prepares and enters required information for Agency/list Setup 209 which is used to control generation of Realtor A Web Site 122 in process Control Tables Information 207. Preferably, Realtor A Web Site 122 is assigned an IP Address and other information is inputted to ensure all necessary data is available when a web page is requested as shown in FIG. 18. Preferably, Realtor A 102 also provides Web Services Provider 101 information regarding areas of specialization which typically include geographic areas within a metropolitan area (such as City of Tempe within the Phoenix metropolitan area) and or particular types of properties (such as horse properties, historic properties, etc.). Preferably, Web Site Generation System 112 uses this information to select, organize and present summary and detail property information on Realtor A Web Site 122. Additionally, required Page Menu Items 210 is completed as shown in FIG. 19. Preferably, Page Menu Items 210 provides the necessary links to support navigation between web pages within Realtor A Web Site 122 including intermediate web pages for various types of properties. Preferably, as shown in FIG. 2 information associated with Page Menu Items 210 and Agency/list Setup 209 is stored in Master Tables Database 218. Refer to Appendix B—Data Management System for details of entry and management of the contents of Master Tables Database 218.

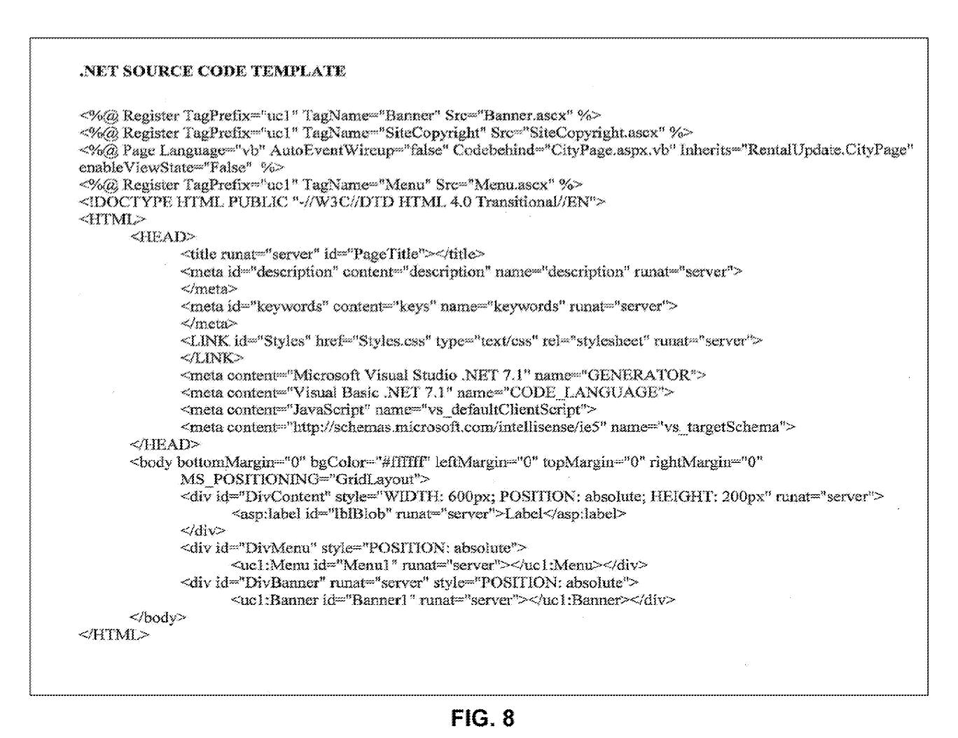

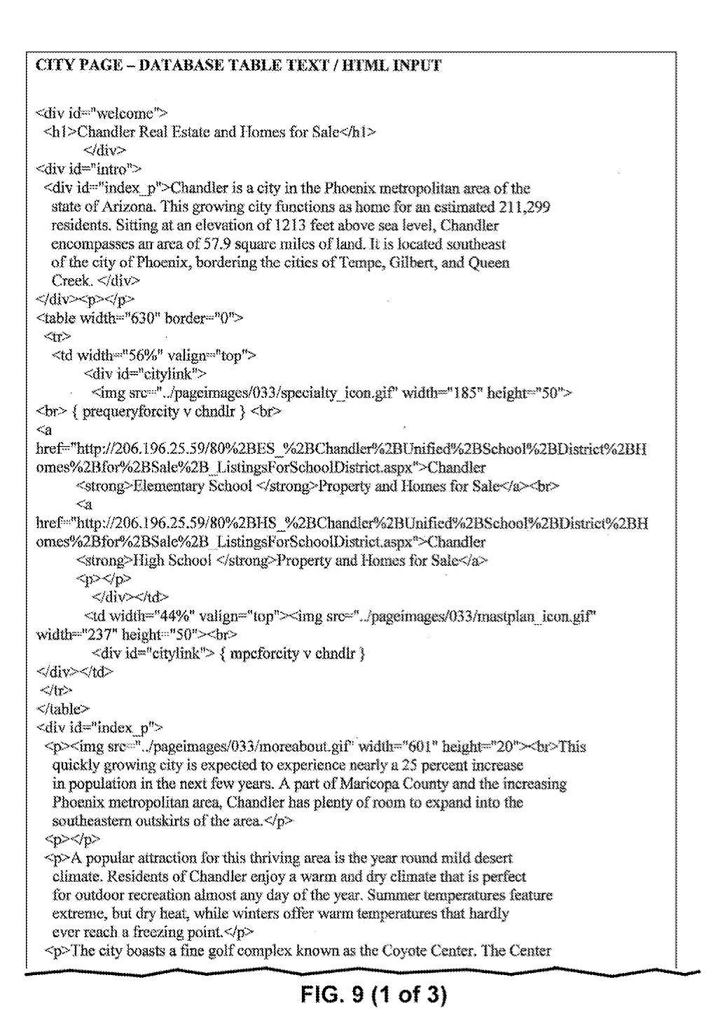

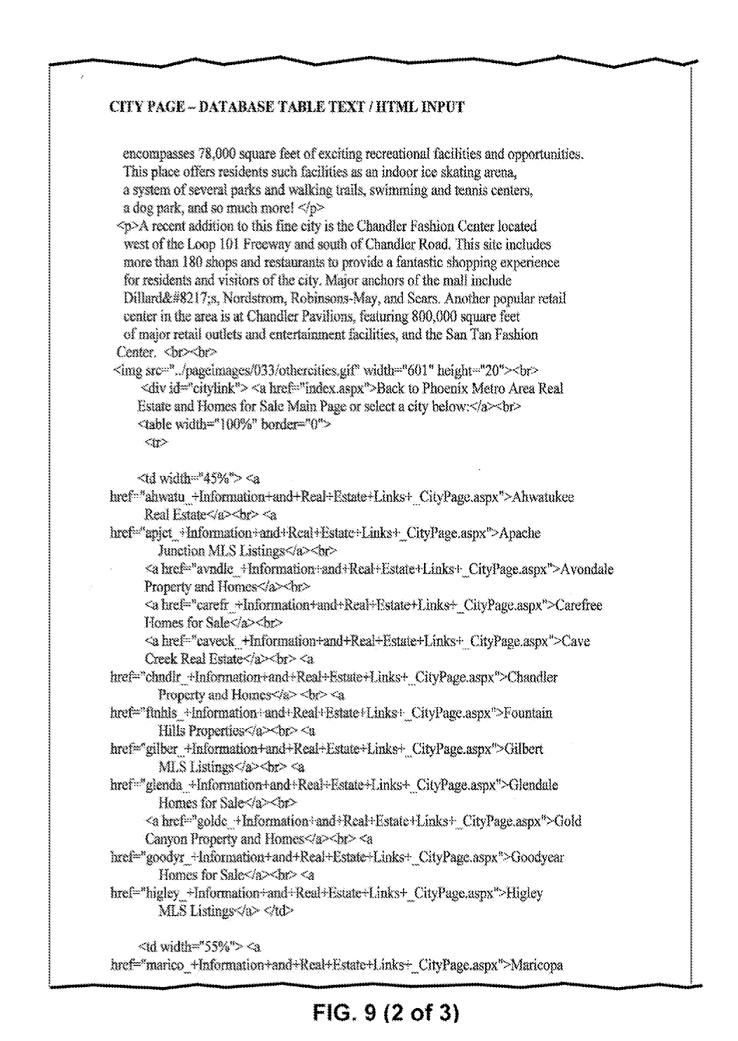

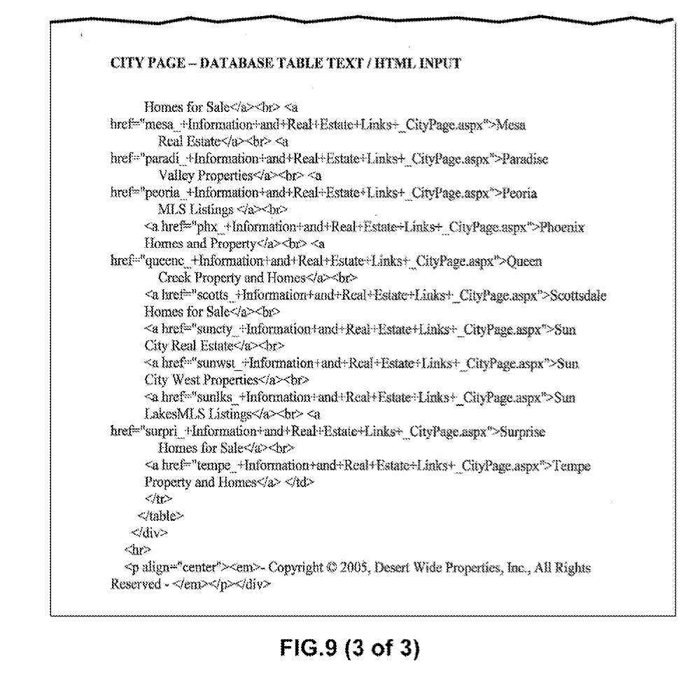

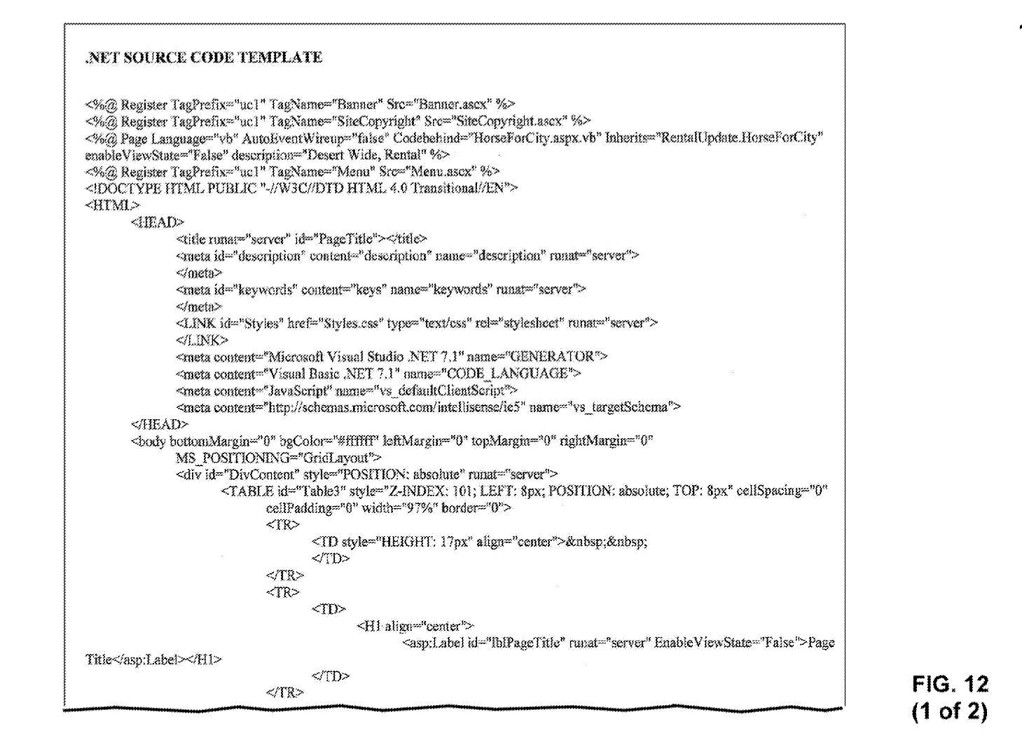

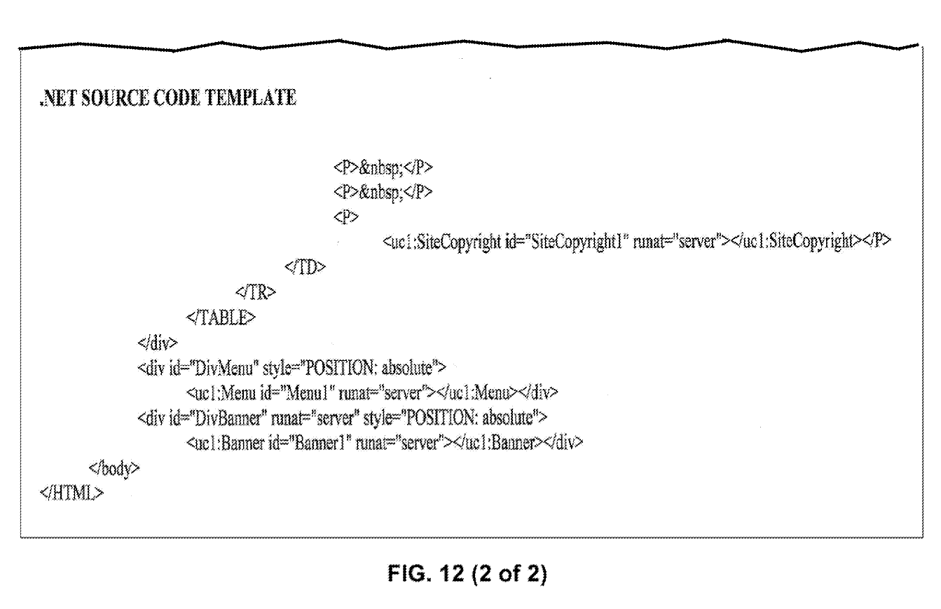

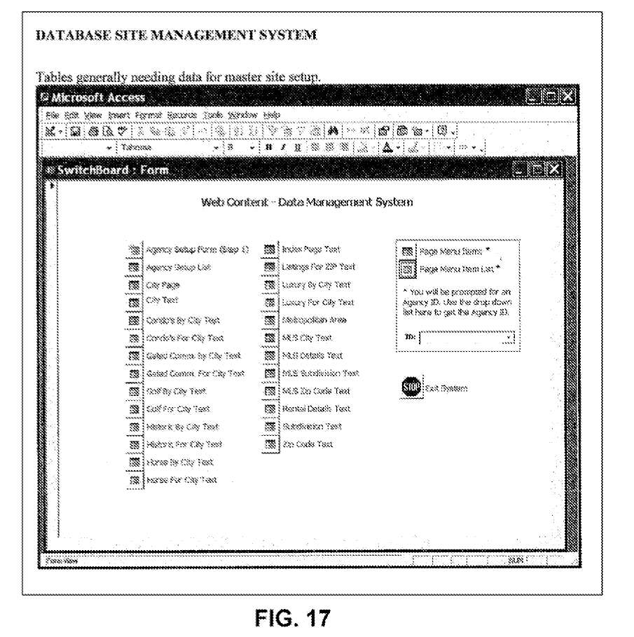

Preferably, Web Services Provider 101 prepares necessary .net Framework source code templates for each unique dynamic page to be presented on Realtor A Web Site 122 (as shown in FIG. 8, FIG. 9, FIG. 12, FIG. 13, FIG. 17, FIG. 18 and FIG. 19) in process HTML Source Code 201. Preferably, .net Framework source code templates are used for generation of Realtor A Web Site 122, Realtor B Web Site 123, Realtor C Web Site 124 and Realtor n Web Site 125 without modification. Thus, each web site can be created as unique from a single set of .net Framework source code very quickly.

Preferably, in process Keywords 220 Web Services Provider 101 compiles a list of Keywords 224 to be used improve indexing results for Realtor A Web Site 122. Preferably, Keywords 224 are inputted to Master Keyword Table which maintained as part of Master Tables Database 218. Preferably, Keywords 224 are used in a coordinated manner for Realtor A Web Site 122 in Anchor Text 901, page titles, headings, body text, meta-tags and alt tags to improve search engine rankings for indexed pages associated with Keywords 224 and to help ensure uniqueness when the same content may be referenced from more than one landing page.

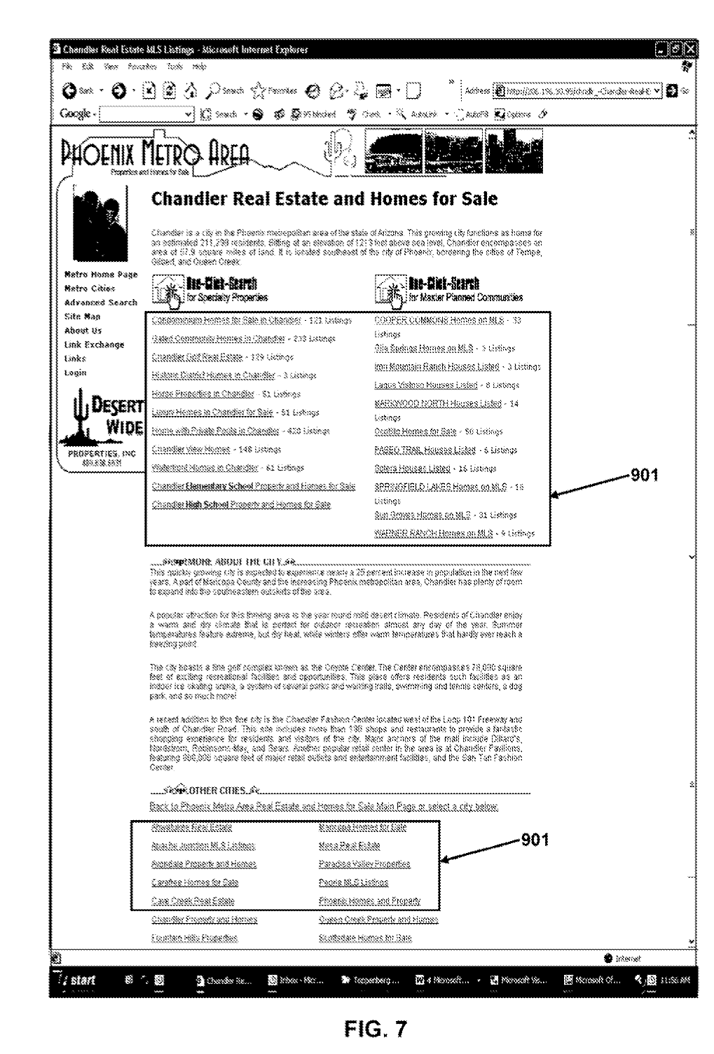

For example, preferably, Anchor Text 901 associated with URL links to database segmentations, such as community, region, property type, specialty properties, etc., used by Realtor A Web Site 122 is randomly re-phrased using contextually appropriate Keywords 224. Preferably, varying Anchor Text 901 associated with URL links to database segmentations helps to ensure uniqueness for each Realtor A Web Site 122 when viewed and indexed by spiders. Additionally, combining appropriate Keywords 224 with variables included within Specialty Page URL 611 permits effective control of how broadly or narrowly relevance is imputed to Keywords 224. Preferably, from the view of search engines, usage of a limited number of Keywords 224 will impute greater weight to each of the selected Keywords 224; conversely less usage of a larger number of Keyword 224 imputes less weight to each selected Keyword 224, but more Keywords 224 are given weight. Refer to FIG. 7 for an example of a typical landing page and Anchor Text 901 which provides examples of how anchor text is modified. Preferably, the Anchor Text 901 is re-phrased by referring to Master Keyword Table, a database table of contextually appropriate keywords randomly selecting contextually appropriate Keywords 224 and limiting their use to their predetermined percentage of all replacements (at least herein embodying computer-generating, on demand, at least one anchor text relating to such at least one uniform resource locator relating to such at least one web page; and at least herein embodying wherein such at least one anchor text comprises such at least one web-search term relevant to such at least one web page).

Preferably, Web Services Provider 101 also completes static text blocks as shown in FIG. 13 and FIG. 16 for general use and for each Realtor A 102. As shown in FIG. 16 Header Text Block 220 can preferably include Merge Variables 223 which can be replaced with Keywords 224 when the text is used in the creation of Realtor A Web Site 122 (at least herein embodying wherein such web-page static content contains at least one replaceable term; and at least herein embodying creating, by at least one web-services provider, at least one web-search keyword list on behalf of each of such plurality of such web-site operators). Thus, each web page where this text block appears will be modified to be relevant to the information being displayed. For example, preferably Merge Variables 223 ([city] and [dwellingtype]) as shown in FIG. 16 are replaced with Keywords 224 “Chandler” and “Home” in Modified Header Text Block 221 as shown in FIG. 14 are relevant to the property web page being generated and displayed and preferably assist in improving spider indexing results (at least herein embodying wherein such at least one web-search keyword list comprises such at least one web-search term; and at least herein embodying replacing, on demand, such at least one replaceable term, with such at least one web-search term). (Refer to Appendix C—Real Estate Keywords and Appendix D—Web Site Variable Replacement Outline for a list of keywords and variables).

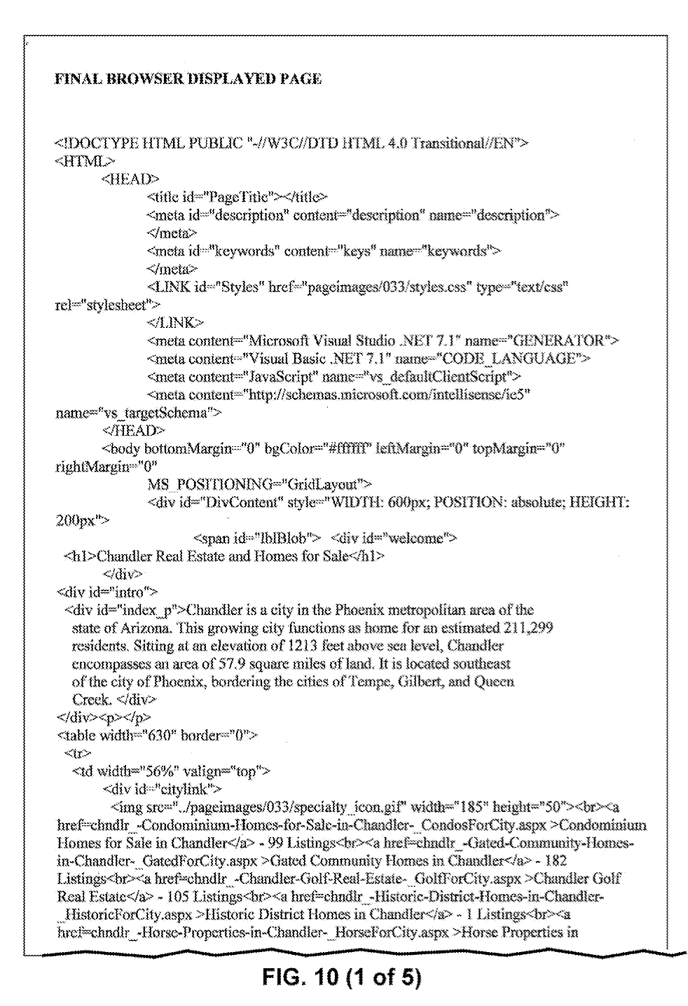

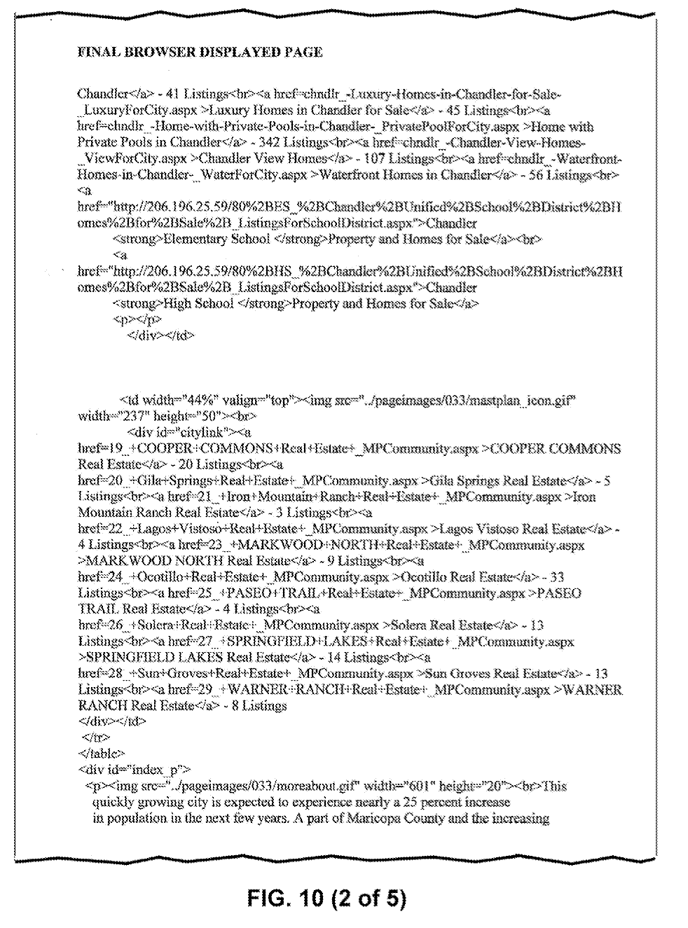

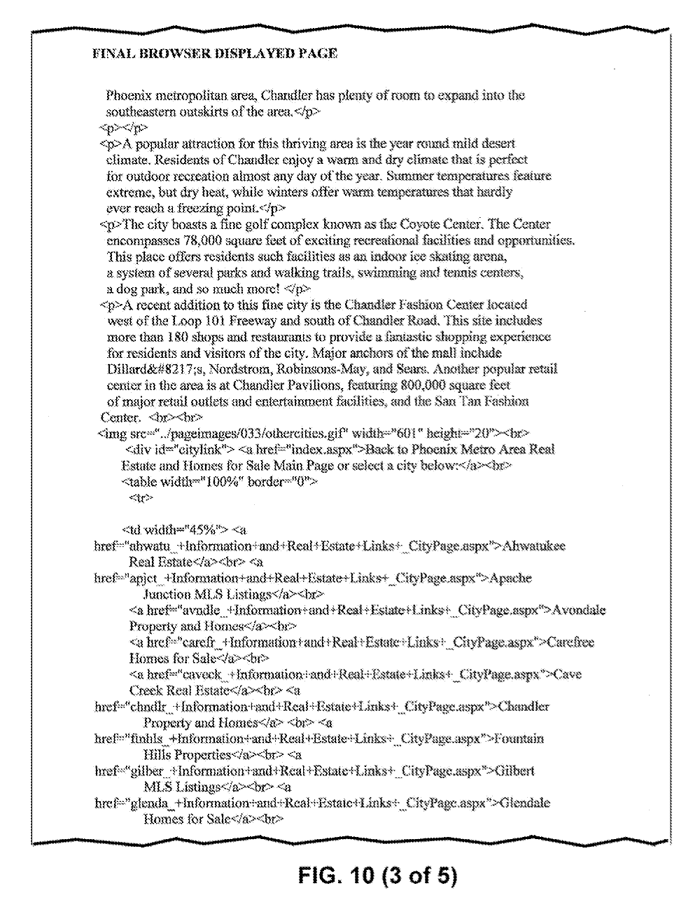

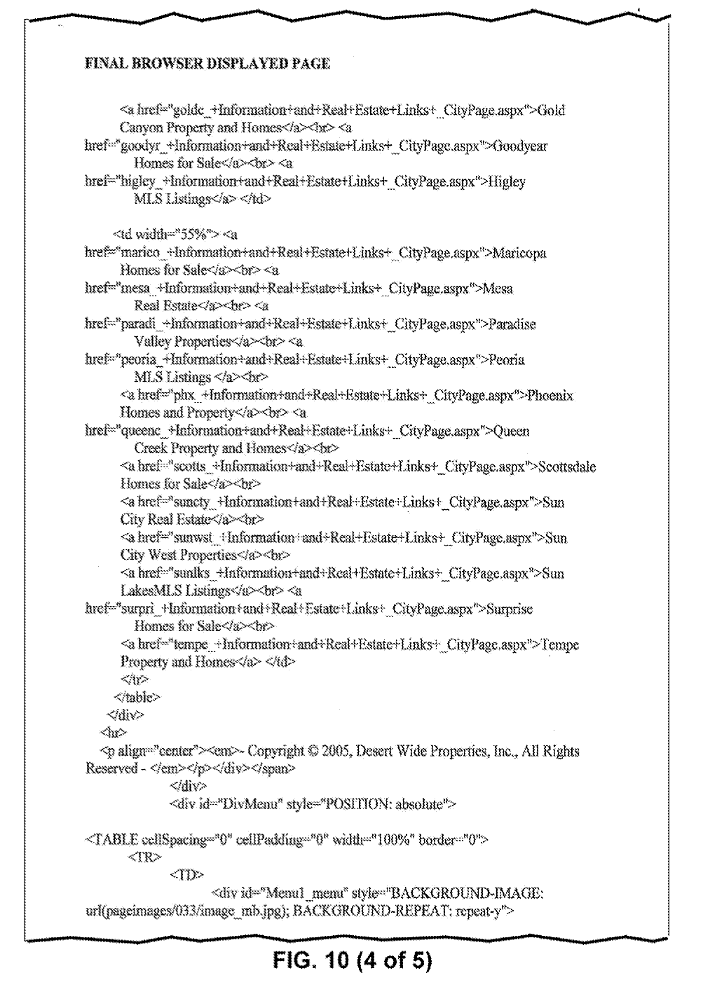

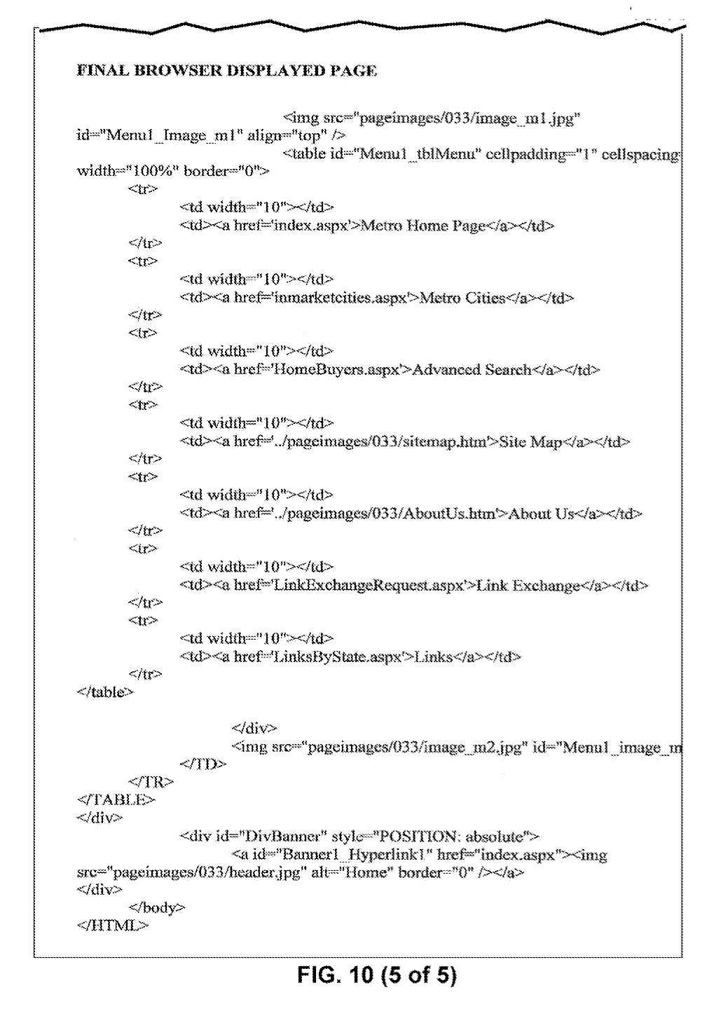

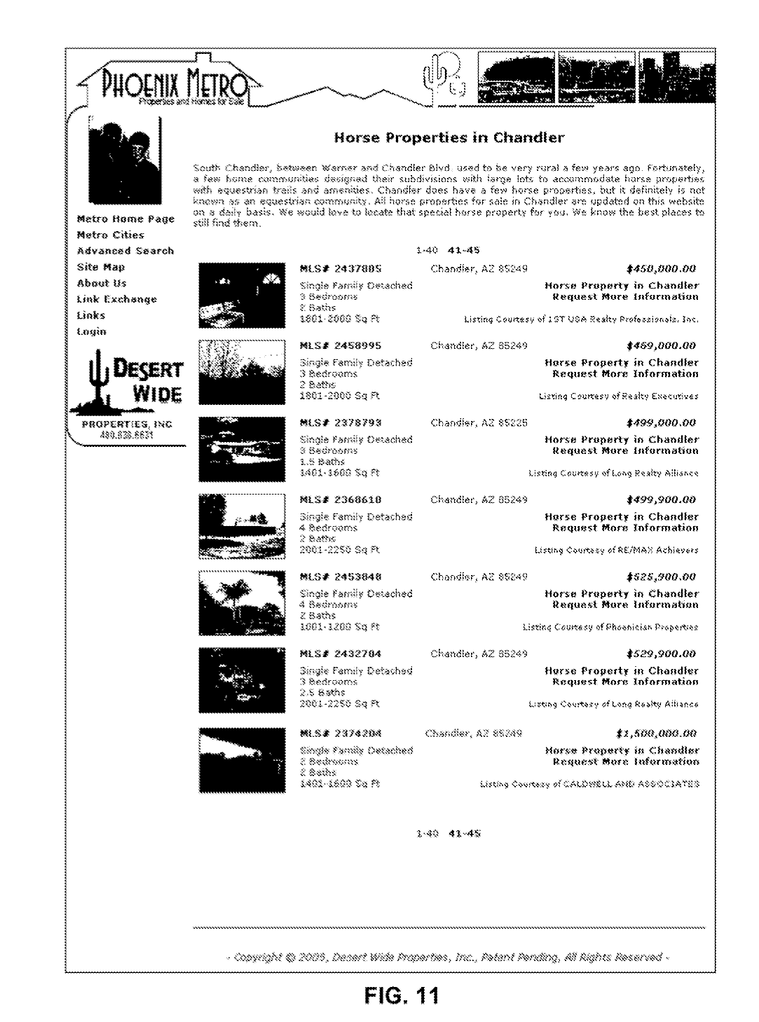

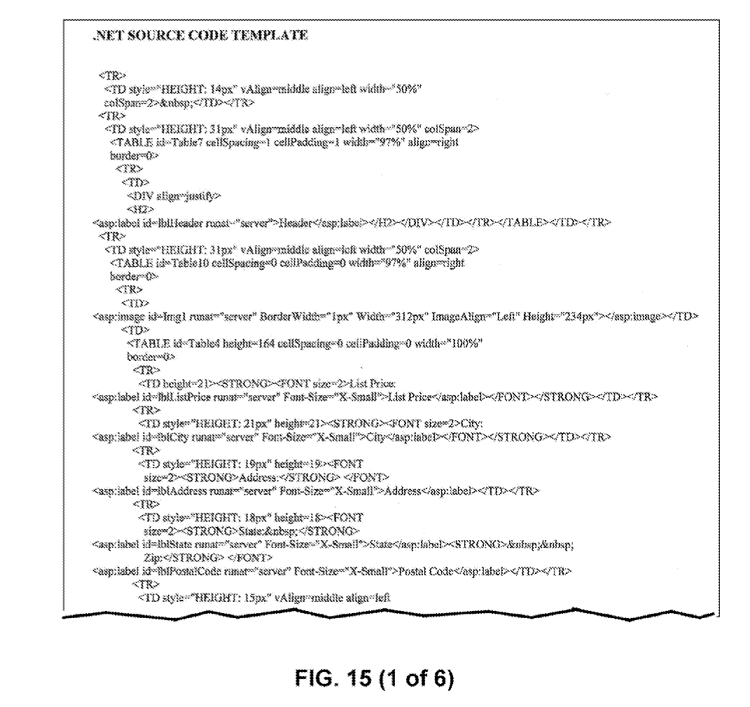

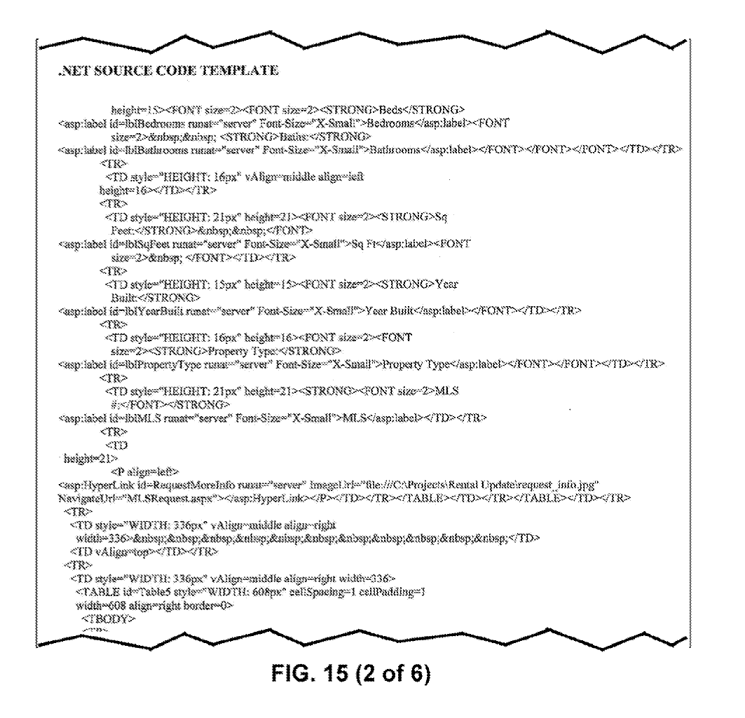

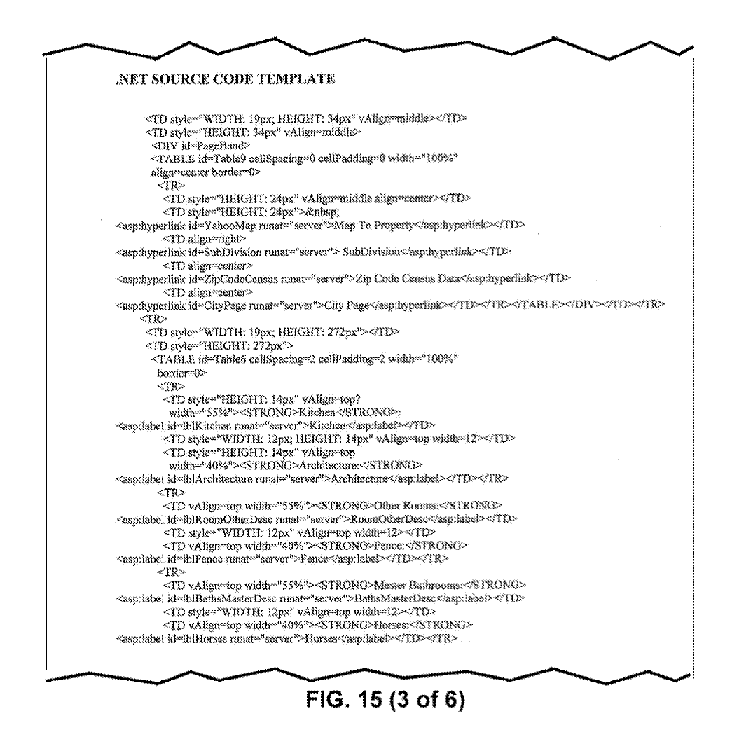

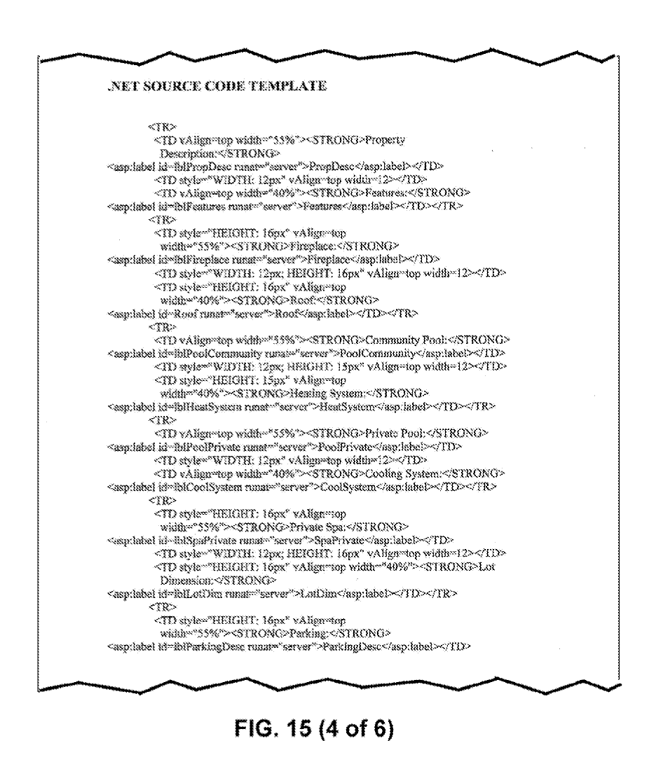

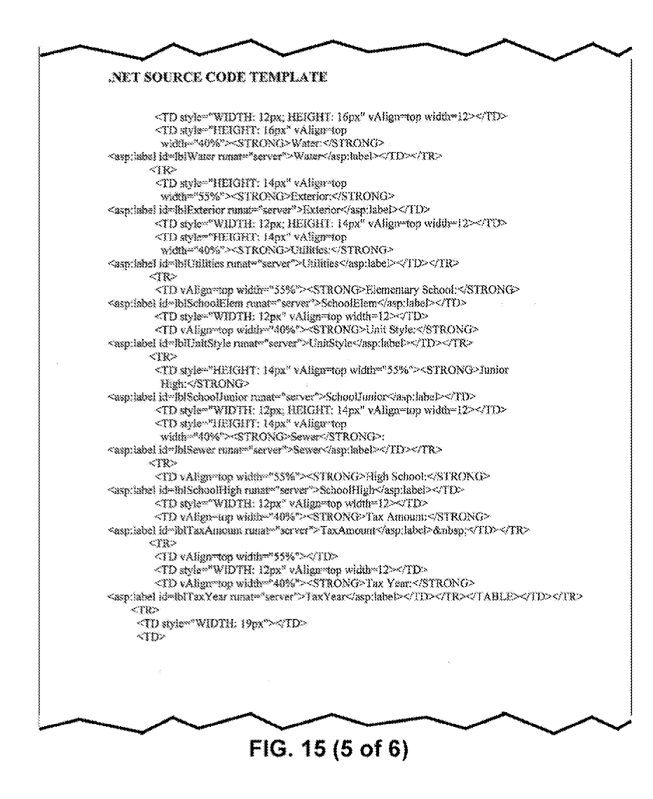

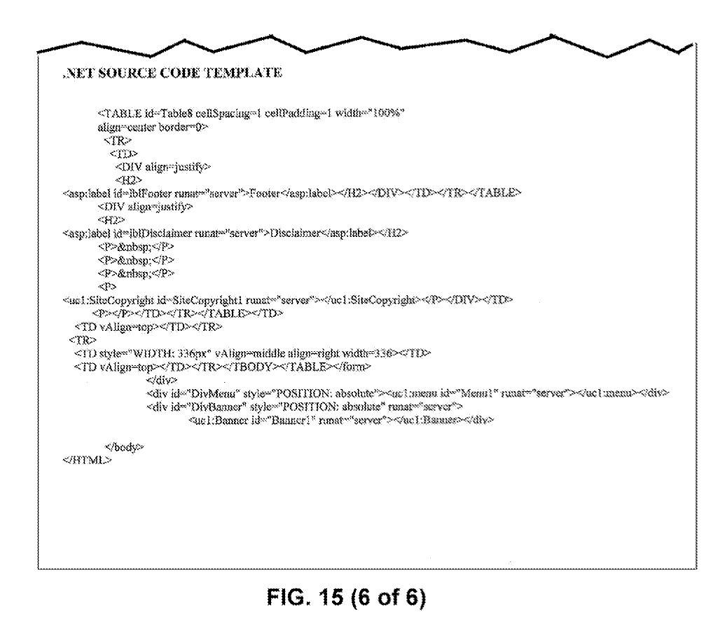

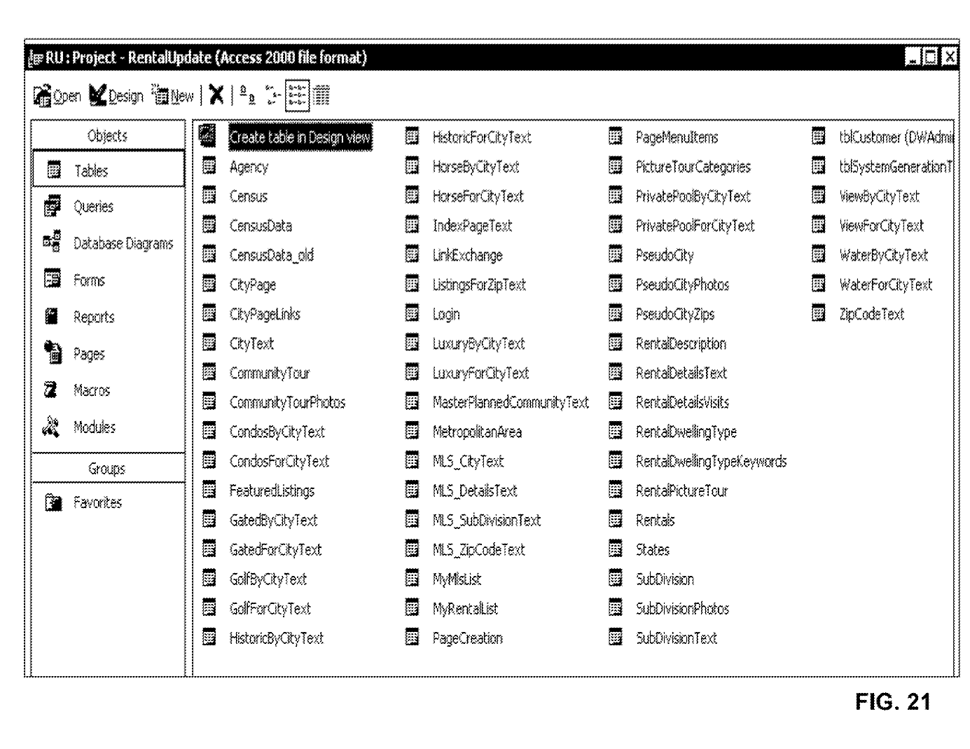

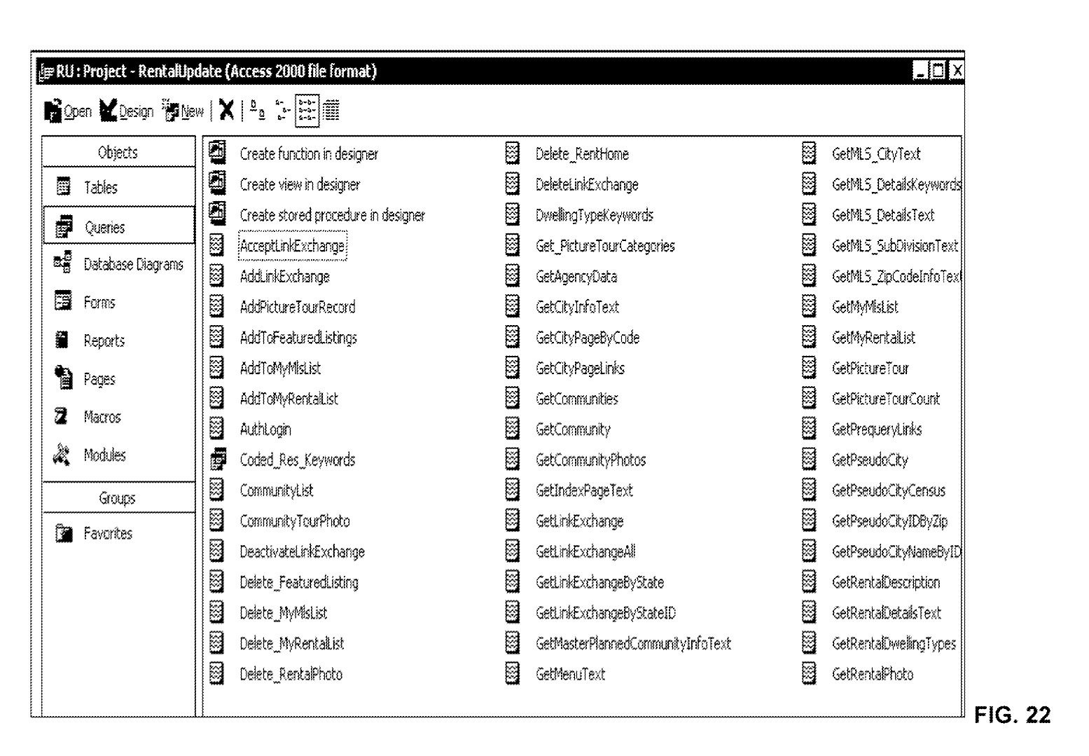

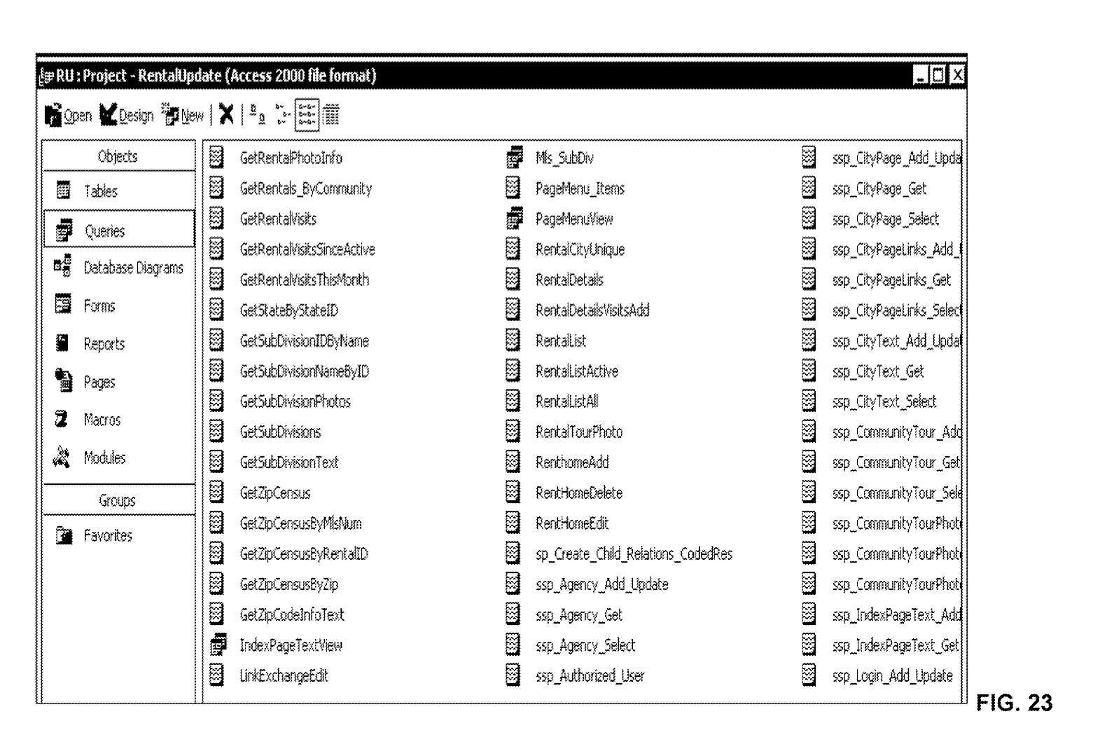

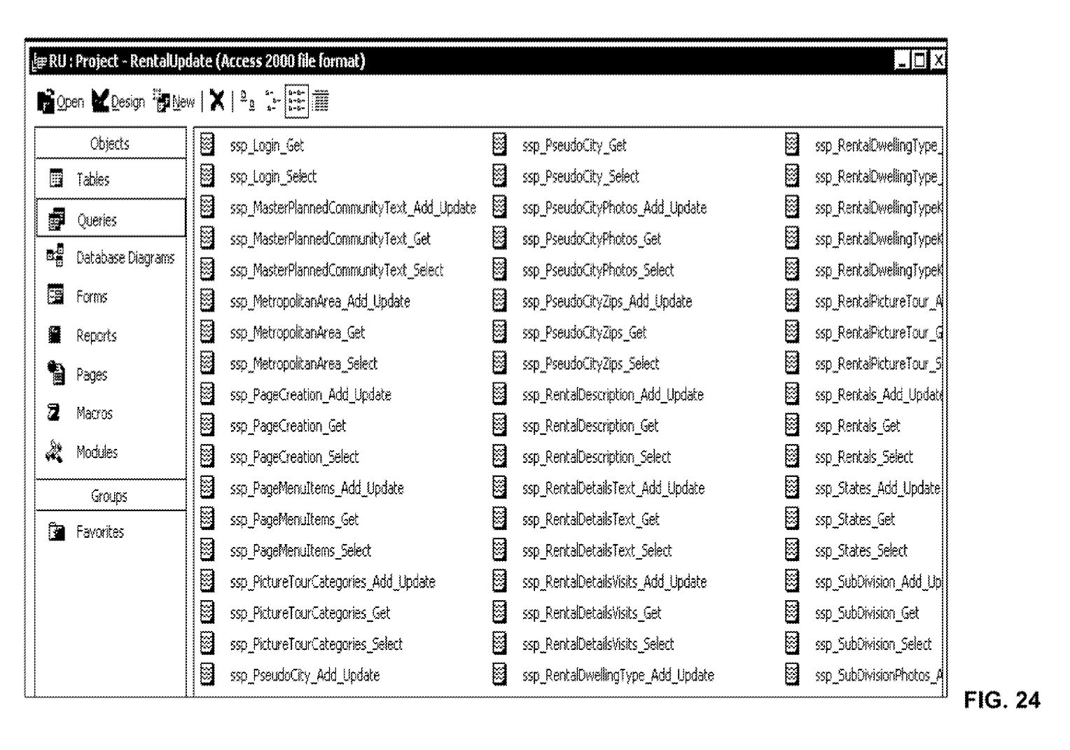

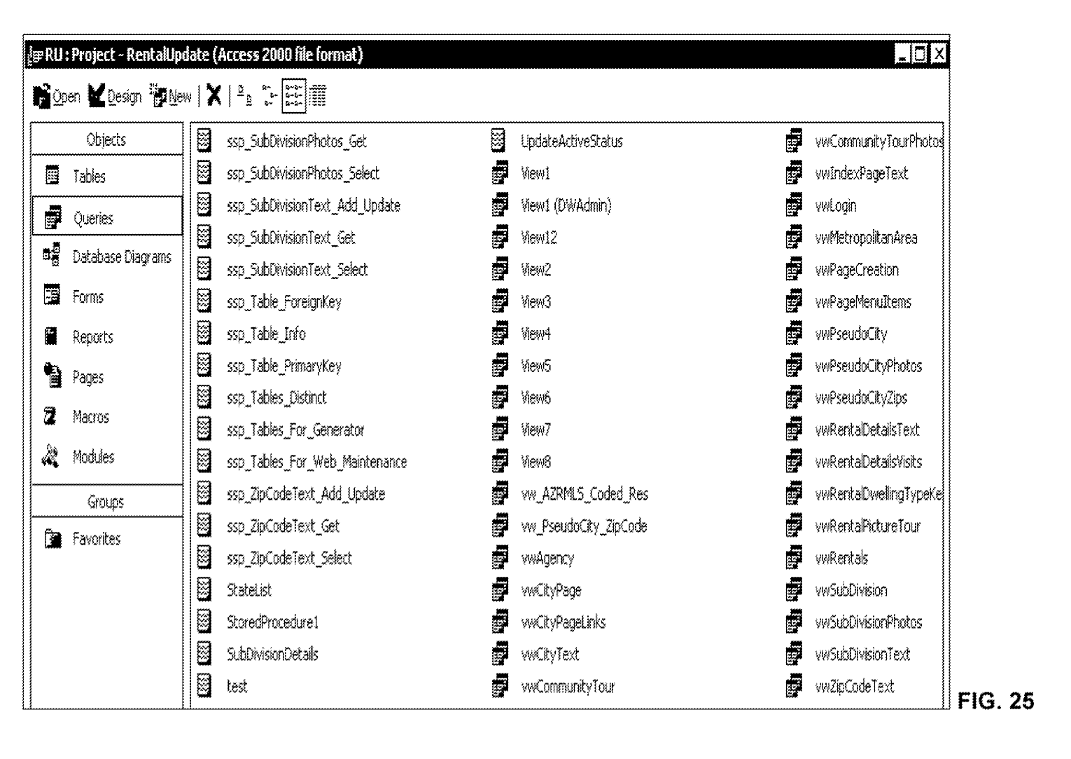

Referring to FIG. 3, an overview schematic of dynamic web page generation system 300 according to a preferred embodiment of the present invention, preferably when Real Estate Buyer 1 107 accesses Realtor A Web Site 122 by entering the URL for Realtor A Web Site 122 into a browser a request is sent to Web Site Generation System 112 where it is received by Web Server 310. Preferably, Web Server 310 evaluates the IP Address of Domain Name 601 (for example www.parsonsteam.com) of the requested URL to determine if it is valid by comparing it to a list of valid IP addresses (provided from Master Tables Database 218), determines related Menu Page Reference 602 for Realtor A Web Site 122 for Master Tables Database 218 and passes it to Application Server 311. Preferably, Application Server 311 will accept Menu Page Reference 602 for Realtor A Web Site 122 and begin preparation of a complete web page by retrieving parametric instructions for Realtor A 102 and required source code templates (See FIG. 8, FIG. 12 and FIG. 15 for source code templates for creating web pages) from Master Tables Database 218, retrieving static web page content as inputted HTML information (See FIG. 9) from Static Page Content Database 217 and retrieving detail property data from MLS Copy Database 215. Preferably, Application Server 311 utilizes pre-coded queries and stored procedures stored in Master Tables Database 218 to complete the necessary retrievals (See FIG. 21 for examples of data tables, queries and stored procedures maintained within Master Tables Database 218 and See FIG. 22, FIG. 23, FIG. 24 and FIG. 25). Preferably, Application Server 311 then assembles a complete set of HTML source code (See FIG. 10) for Realtor A Web Page 301 which can be used by web browser of Real Estate Buyer 1 107 to render the requested web page (See FIG. 7, FIG. 11 and FIG. 14 for examples of generated web pages). Preferably, the generated source code is then returned to Web Server 310 which in turn provides it to the web browser being used by Real Estate Buyer 1 107 which then renders requested Realtor A Web Page 301 in a visible form for Real Estate Buyer 1 107 (at least herein embodying computer-generating, on demand, using such received web-page content display parameters, at least one web page containing at least some of such uploaded content for at least one web-site operator of such plurality of such web site operators).

Preferably, Web Server 310 utilizes functions provided by Microsoft IIS and Application Server 311 relies on Microsoft .net Framework services and functions. Upon reading the teachings of this specification, those with ordinary skill in the art will now understand that, under appropriate circumstances, considering such issues as changes in technology and software capabilities, software offered by other software vendors, such as Sun Microsystems Inc., may suffice.

Preferably, Realtor A Web Page 301 (representative of all generated web pages) contains one or more URL's generated by Application Server 311 which are links to other web pages within Realtor A Web Site 122 (at least herein embodying computer-generating, on demand, at least one uniform resource locator relating to such at least one web page). Preferably, all URL's generated and contained within Realtor A Web Page 301 will be interpreted by search engine indexing programs (spiders) as being URL's for static web pages (at least herein embodying wherein such at least one uniform resource locator is indexable by at least one Internet-based-indexing computer program). Preferably each web page is generated with Anchor Text 901, associated with each URL reference, such as Specialty Page URL 611, which includes contextually correct Keywords 224 related to Keywords 224 also used within the generated HTML detail web page, including page title, heading, body text, meta-tags and alt tags (at least herein embodying wherein such at least one uniform resource locator comprises at least one web-search term relevant to such at least one web page). Preferably, selection of Keywords 224 is from Master Keyword Table contained within Master Tables Database 218. Preferably, content of Anchor Text 901 is based on content of generated detail web pages referenced by landing pages (as shown in FIG. 7) to either reinforce relevance of narrowly focused keywords or to impute relevance to a wide range of keywords, depending on the setting of the weighted randomizer (at least herein embodying computer-generating, on demand, at least one anchor text relating to such at least one uniform resource locator relating to such at least one web page; and at least herein embodying wherein such at least one anchor text comprises such at least one web-search term relevant to such at least one web page). Preferably, each Keyword 224 is assigned a weight reflecting the desired frequency with which it will be used. Preferably, the assigned weight is considered when randomly selecting Keywords 224 (at least herein embodying wherein such at least one web-search term is selected from such at least one web-search keyword list).

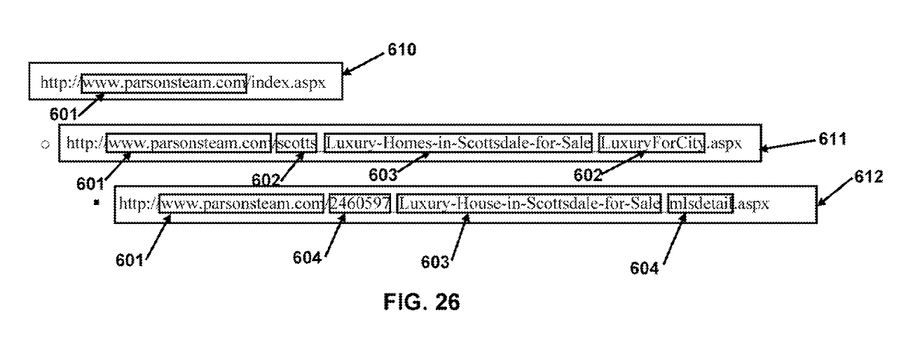

Examples of generated URL references are shown in FIG. 26. As shown, each generated URL preferably contains Domain Name 601, Menu Page Reference 602 and Captured Variables 603. Preferably, in these examples, Captured Variables 603, contained within the underscores are programmatically selected, based on content of detail property web page content referenced by Specialty Page URL 611, and inserted to provide uniqueness and relevancy to each generated URL when it is indexed by a search engine indexing programs (spiders) from search engine providers (at least herein embodying wherein such at least one web-search term is selected from such at least one web-search keyword list). Preferably, Menu Page Reference 602 is inputted and stored in Master Tables Database 218 for each geographic area or type of property in which Realtor A 102 specializes.

Preferably, when Real Estate Buyer 2 108 conducts a search for a luxury home for sale in Scottsdale using a search engine such as Google or Yahoo one of the URL's that may be returned is “http://www.parsonsteam.com/2460597_Luxury-House-in-Scottsdale-for-Sale_mlsdetail.aspx”. If Real Estate Buyer 2 108 selects this URL he/she will be presented with the requested web page preferably generated by Web Site Generation System 112. Preferably, Web Server 310 receives the requested URL, evaluates the IP Address of Domain Name 601 (for example www.parsonsteam.com) to determine if it is valid by comparing it to a list of valid IP addresses (provided from Master Tables Database 218), determines related Menu Page Reference 602 (as shown in FIG. 26) for Realtor A Web Site 122 for Master Tables Database 218 and passes it to Application Server 311. Preferably, Application Server 311 will accept Menu Page Reference 602 for Realtor A Web Site 122 and begin preparation of a complete web page by retrieving parametric instructions for Realtor A 102 and required source code templates (See FIG. 8, FIG. 12 and FIG. 15 for source code templates for creating web pages) from Master Tables Database 218, retrieving static web page content as inputted HTML information (See FIG. 9) from Static Page Content Database 217 and retrieving detail property data from MLS Copy Database 215. Preferably, Application Server 311 then assembles a complete set of HTML source code (See FIG. 10) for Realtor A Web Page 301 which can be used by web browser of Real Estate Buyer 2 108 to render the requested web page (See FIG. 7, FIG. 11 and FIG. 14 for examples of generated web pages). Preferably, the generated source code is then returned to Web Server 310 which in turn provides it to the web browser being used by Real Estate Buyer 2 108 which then renders requested Realtor A Web Page 301 in a visible form for Real Estate Buyer 1 107.

Preferably, Web Site Generation System 112 accumulates a count of requests for each Realtor A Web Page 301 included in Realtor A Web Site 122 for the purpose of preparing statistical analyses. Preferably, these analyses may be completed with respect to any data field provided as part of MLS Database 115. Thus, preferably statistical analyses may be prepared for Realtor A 102 as well as between Realtor A 102 and Realtor B 103 or any other combination of data fields and Realtor A 102 and Realtor B 103. Preferably, such statistical analyses are useful as metrics of activity over time and for identifying market trends.

Referring to FIG. 4, which shows an overview schematic of dynamic web page generation process flow when a web page is requested through a realtor's home page according to a preferred embodiment of the present invention, in step Request Realtor Web Site 401 an Internet user or spider requests the home page for Realtor A Web Site 122. Preferably, requested Home Page URL 610 is received by Web Site Generation System 112 and Domain Name 601 is translated to the assigned IP address for Realtor A Web Site 122 in step Translate Requested IP to Realtor 402 (at least herein embodying determining, automatically, such content of each such web page of such plurality of web pages to be generated; and at least herein embodying wherein such determining is based on at least one domain name portion of such at least one uniform resource locator relating to such at least one web page). Preferably, in step Query Realtor Databases 403 the translated IP address is used to retrieve parametric instructions for Realtor A 102, required source code templates, URL links (such as Property Detail URL 612 and Specialty Page URL 611) and Keywords 224 are retrieved from Master Tables Database 218, and static web page content from Static Page Content Database 217. Preferably, in step Generate Home Page 404 complete HTML code is generated from the retrieved information. Preferably, in step Generate Summary 405 a list of summary links is obtained. Additionally, preferably appropriate Keywords 224 are programmatically inserted as meta-tags within the meta-tag section of the generated source code and preferably any Merge Variables 223 found in text to be used on the generated page will replaced with relevant Keywords 224 (at least herein embodying inserting, programmatically, such selected at least one web-search term as at least one meta-tag into each such web page of such plurality of web pages; and at least herein embodying wherein such selected at least one web-search term is relevant to such content of each such web page of such plurality of web pages). Finally, the generated source code is returned to the user as a visible web page or as source code to a spider (See FIG. 7).

Preferably, in step Select Summary Link 406, the user or spider selects Specialty Page URL 611 to request another web page contained within the Realtor A Web Site 122 which includes all properties meeting the particular geographic or specialty criteria contained within the Specialty Page URL 611. However, in certain situations, instead of a list of properties, another web page with additional summary links is generated. In such cases, preferably the step Generate Summary 405 is again performed. Preferably, a “silo” data structure is used to track levels of themed content. A silo data structure is any data structure that can store a hierarchy of themed content. For example, if the theme is “Phoenix real estate”, the silo might contain the topics “Phoenix condos”, “Phoenix luxury homes”, “Phoenix golf properties” on the first level. One or more of these topics might themselves contain further themed content on the next level. For example, the category “Phoenix luxury homes” might be further broken down to “Phoenix luxury homes over $2 million” and “Phoenix luxury homes under $2 million”. Preferably, related MLS listings can be integrated into any specific level that is theme-related to the level's content and optimized to support the topic of the level. Preferably, desirable market-specific attributes within the market are utilized to create “market spaces”. For example, selecting real estate listings on price allows properties to be characterized as “luxury” or “affordable”. Preferably, real estate listings are associated with the market space for which they share at least one attribute. In general, the number of categories is driven by database content (e.g., the number of attributes that can be parsed from an MLS listing) and the type of property that an individual real estate agent wishes to focus on selling. Preferably, the step Generate Summary 405 and Select Summary Link 406 are repeated until the user or spider requests a Specialty Page URL 611 associated with themed content at the “bottom” of the silo data structure (e.g., at a level that is not further broken down).

Preferably, in step Query Realtor and MLS Databases 407 requested Specialty Page URL 611 is received by Web Site Generation System 112 translated and queries made to Master Tables Database 218, Static Page Content Database 217 and MLS Copy Database 215 to complete generation of source code for requested specialty web page (See FIG. 11). Preferably, in step Generate Properties List and URLs 408, source code for requested web page including generation of Property Detail URL 612 for each real property meeting the particular geographic or specialty criteria contained within Specialty Page URL 611 is generated and returned to the requester, user or spider. Additionally, preferably of appropriate keywords are programmatically inserted as meta-tags within the meta-tag section of the generated source code and preferably any Merge Variables 223 found in text to be used on the generated page will replaced with relevant keywords and phrases.

In step Select Property Detail URL 409, user or spider selects Property Detail URL 612 relating to a particular real property. Preferably, in step Query Realtor and MLS Databases 410 selected Property Detail URL 612 is received by Web Site Generation System 112 translated and queries made to Master Tables Database 218, Static Page Content Database 217. Preferably, MLS property details are retrieved from MLS Copy Database 215 using MLS Detail Reference 604 portion of Property Detail URL 612 to obtain information to complete generation of source code for requested property detail web page (See FIG. 14).

In step, Generate Property Detail Page 411 Web Site Generation System 112 completes generation of requested property detail page including programmatic insertion of appropriate keywords as meta-tags within the meta-tag section of the generated source code for the requested property detail web page. Additionally, preferably any Merge Variables 223 found in text to be used on the generated page will be replaced with relevant keywords and phrases. Finally, the requested web page is returned to the user or spider requesting it.

Referring to FIG. 5, which shows an overview schematic of dynamic web page generation process flow when a web page is requested from a search engine results page according to a preferred embodiment of the present invention, in step Select Search Engine Search Results Link 501, a user completes a web-based search using keywords such as “luxury home scottsdale” with a search engine provider web site such as Google.com or Yahoo.com. Search engine results web page returned by the user's request will include one or more Property Detail URL 612 because it appears to be a static URL and therefore has been indexed by a spider operating on behalf of a search engine provider. Preferably, user selects Property Detail URL 612 and the request is received by Web Site Generation System 112.

Preferably, in step Translate Requested IP to Realtor 502, Web Site Generation System 112 receives Property Detail URL 612 which includes Domain Name 601. Preferably, Domain Name 601 is translated to the assigned IP address for Realtor A Web Site 122.

Preferably, in step Query Realtor and MLS Databases 503 the translated IP address is used to retrieve parametric instructions for Realtor A 102 and required source code templates are retrieved from Master Tables Database 218, and static web page content from Static Page Content Database 217. Preferably, MLS detail is retrieved from MLS Copy Database 215 using MLS Detail Reference 604 portion of received Property Detail URL 612.

Preferably, in step Generate Property Detail Page 504, Web Site Generation System 112 completes generation of requested property detail page including programmatic insertion of appropriate keywords as meta-tags within the meta-tag section of the generated source code for the requested property detail web page. Additionally, preferably any Merge Variables 223 found in text to be used on the generated page will be replaced with relevant keywords and phrases. Finally, the requested web page is returned to the user it.

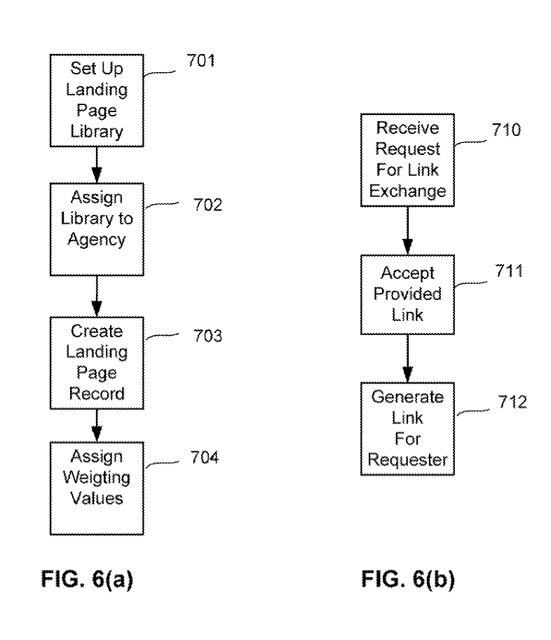

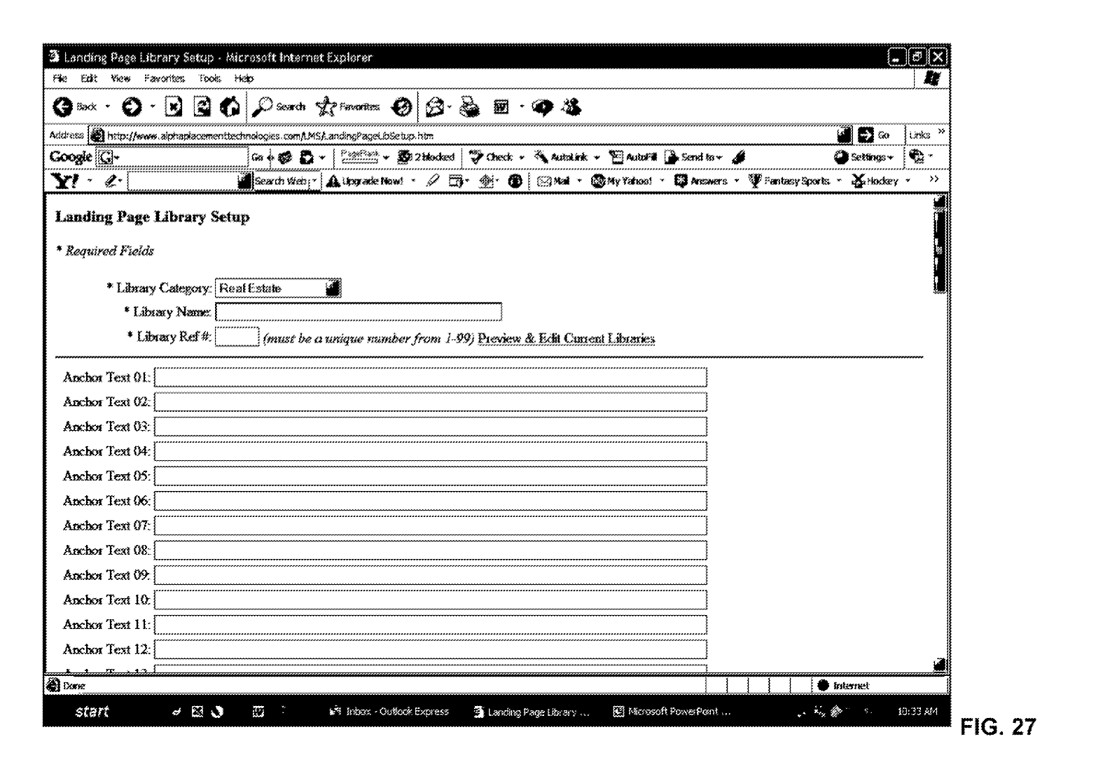

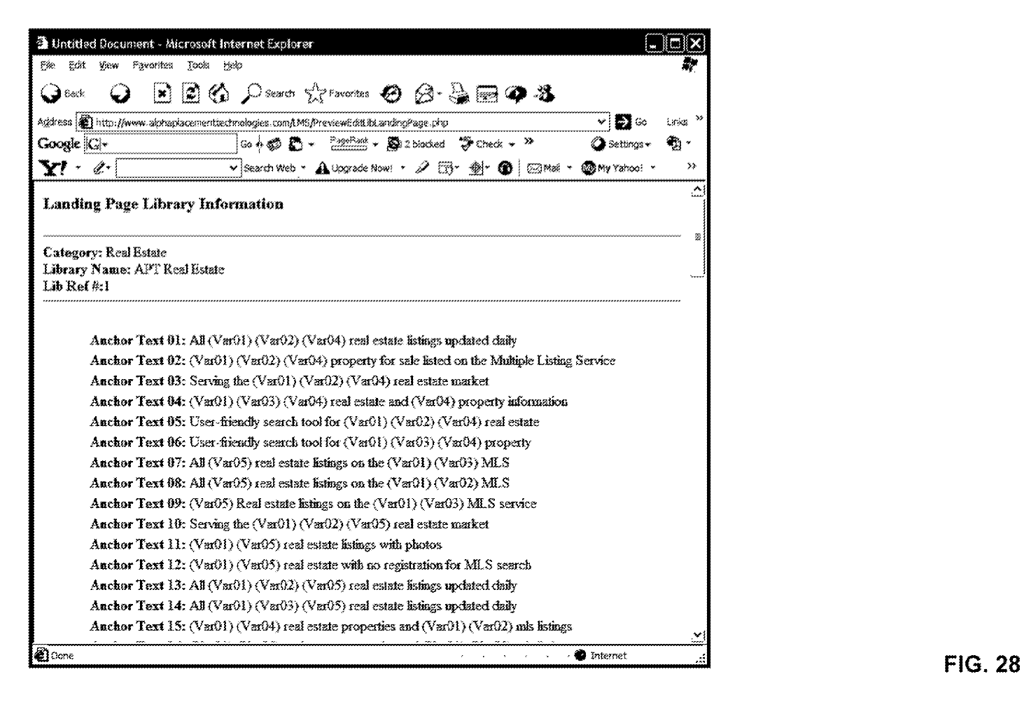

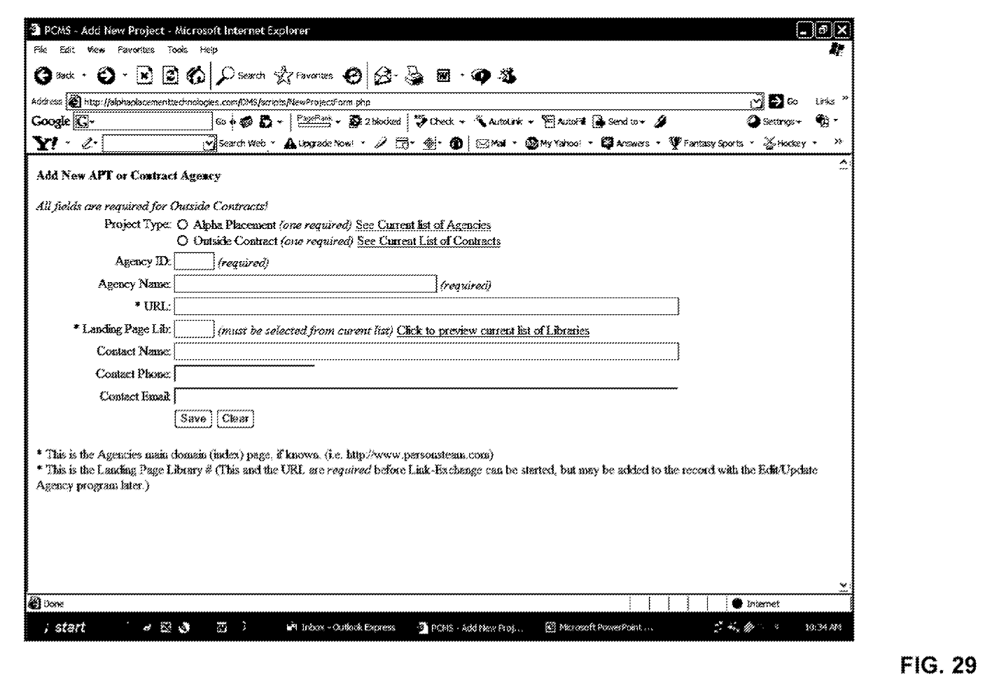

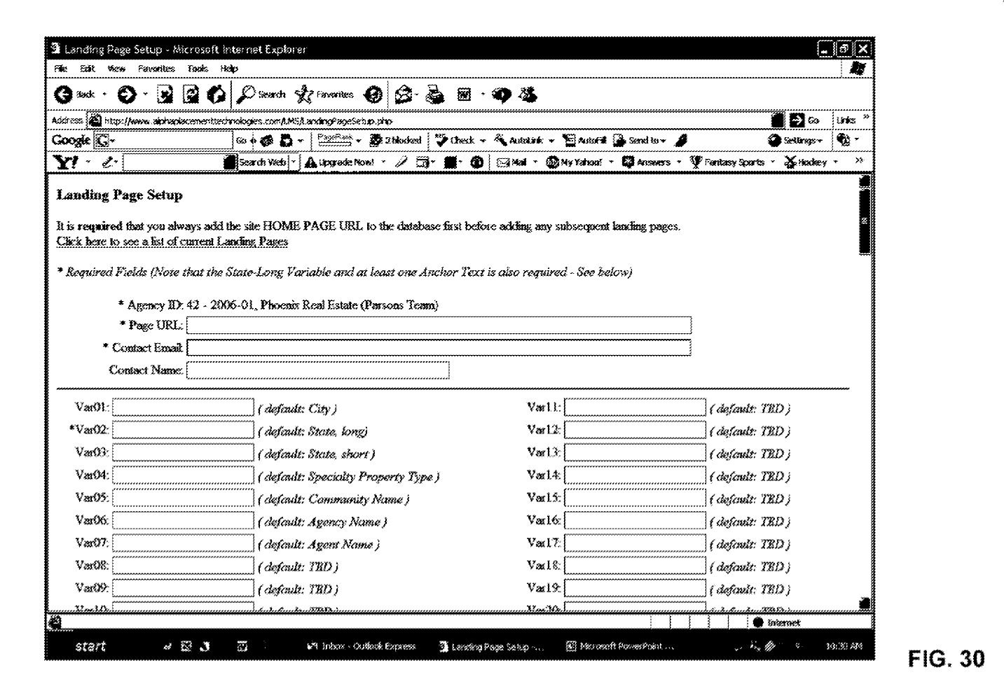

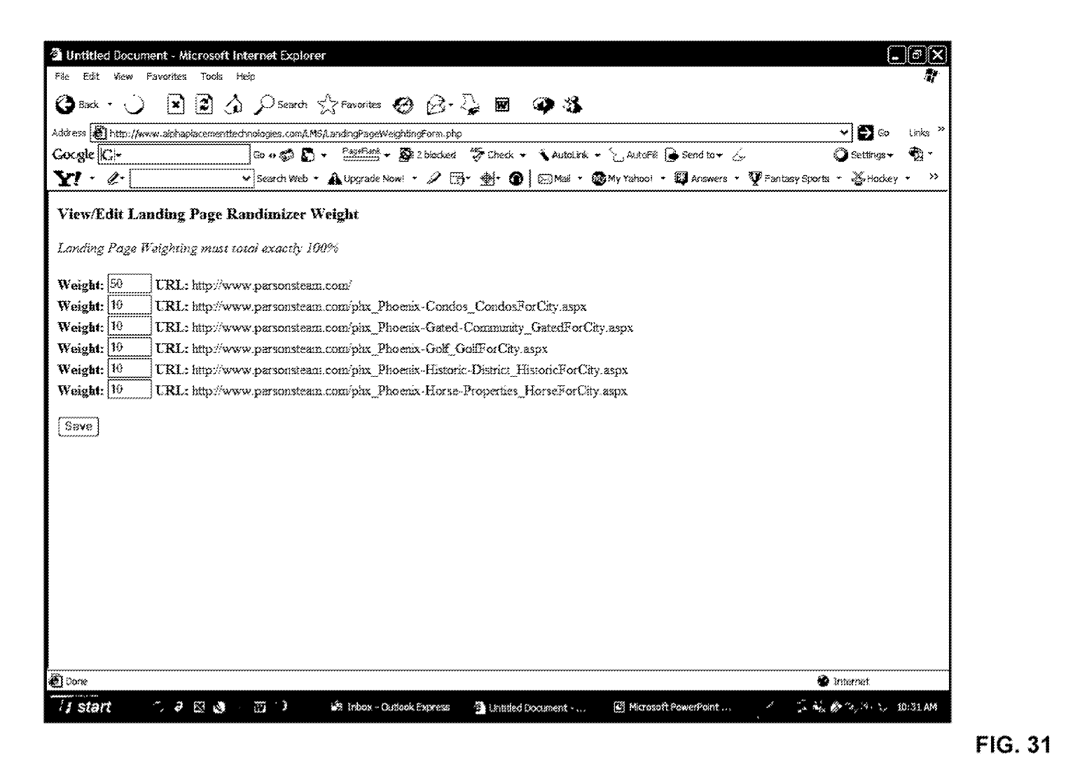

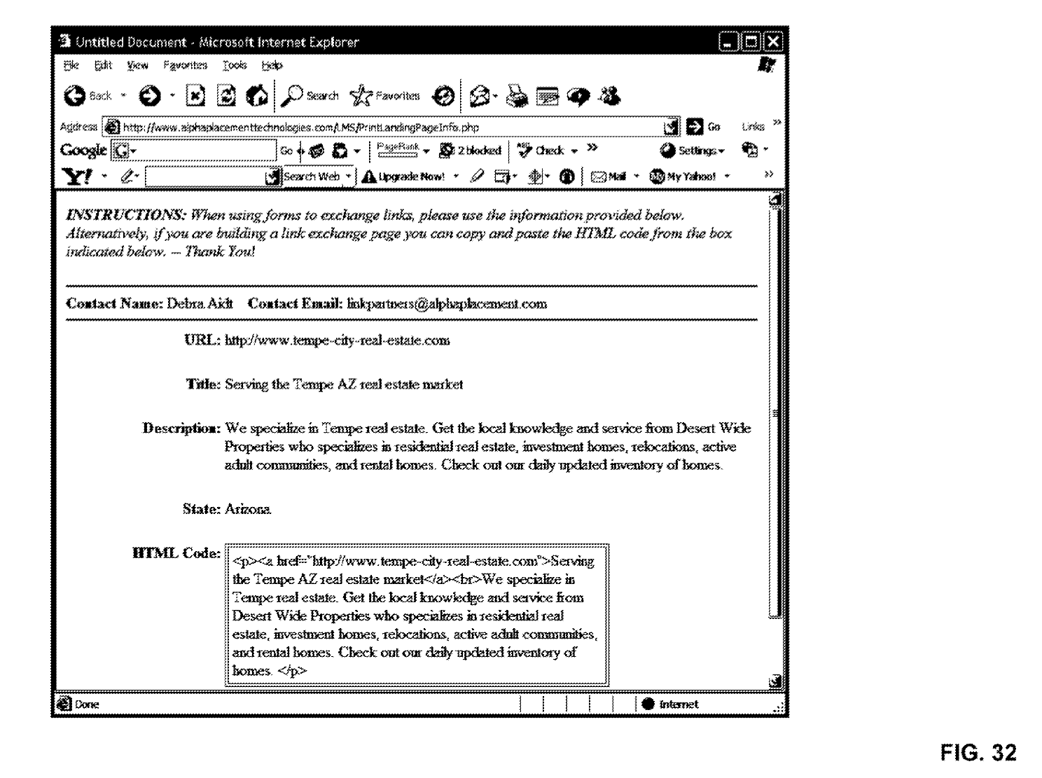

According to a preferred embodiment of the present invention, a link exchange is provided to encourage traffic to be driven to at least one web-site. In addition to driving traffic via external linking to the at least one web-site, the link exchange described herein is designed to enhance search engine ranking. Referring to FIG. 6(a), which shows an overview schematic of a link exchange set-up process flow, in step Set Up Landing Page Library 701, a landing page library is created. Preferably, a web site operator (e.g., Realtor A) defines a set of Anchor Text and Description Templates. Preferably, these Anchor Text and Description Templates employ industry-specific keywords. (FIG. 27 is an example of a set-up screen for entering information to set up a landing page library. FIG. 28 is an example of a preview screen for previewing the provided landing page library information). In step Assign Library to Agency 702, the landing page library is assigned to a particular customer (e.g., Realtor A). (FIG. 29 shows an example of a screen for inputting information for assigning a landing page library to a particular customer). In step Create Landing Page Record 703, a landing page record is created (preferably one for each landing page chosen within a web site.) Preferably, the URL of the landing page is specified along with one or more variable that are used to create web page text that encourage indexing by a spider. (FIG. 30 shows a screen for creating a landing page record). A main idea of the link exchange feature described herein is to rotate generated links to landing pages according to a random or a predetermined selection probability. In step Assign Weighting Values 704, preferably, after all the landing page records are created, a weighting value is assigned to each of the landing pages. For example, as shown in FIG. 31, the landing page “http://www.parsonsteam.com” is assigned a 50% weight, the landing page “http://www.parsonsteam.com/phx_Phoenix-Condos_CodosForCity.aspx” is assigned a 10% weight, the landing “http://www.parsonsteam.com/phx_Phoenix-Golf_GolfForCity.aspx” is assigned a 10% weight, the landing page “http://www.parsonsteam.com/phx_Phoenix-Historic-District_HistoricForCity.aspx” is assigned a 10% weight, and the land page “http://www.parsonsteam.com/phx_Phoenix-Horse-Properties_HorseForCity.aspx” is assigned a 10% weight. In this example, a link to the web site home page (“http://www.parsonsteam.com”) will be provided half the time to someone requesting a link exchange. Links to any of the remaining landing pages will be provided to a party requesting a link exchange ten percent of the time. Referring to FIG. 6(b), which shows an overview schematic of the link exchange feature in operation, in step Receive Request for Link Exchange 710, an operator of a web site requests a link exchange. Preferably, this link exchange request is accomplished via screen input. For example, the web site operator of web site http://www.website1.com might enter information in a web-based form provided on web page http://www.linkexchange/parsonsteam.com requesting web sites to exchange links. Preferably, the form would require that the URL of the requester's link be entered. In step Accept Provided Link 711, the entered URL of the requester's link is accepted. Preferably, the accepted URL would be displayed on a web-site to fulfill the agreement to exchange links. In step Generate Link For Requester 712, a link is generated for the Requester along with text describing the landing page which the link is associated with. Preferably, actual HTML code is generated with the URL of the landing page and description text encoded therein. (FIG. 32 shows an example of information that would preferably be displayed to the requester. Note that this information includes instructions for copying and pasting the generated HTML coding to the requester's web-site.)

According to a preferred embodiment of the present invention, generated web page source code, as described with reference to FIG. 3, FIG. 4 and FIG. 5, is optimized to produce the possible search engine indexing results for Realtor A 102. Preferably, Web Services Provider 101 observes and analyzes search engine indexing methods to determine the most effective means for creation of dynamic and static web pages. Preferably, Web Services Provider 101 uses various search engine optimization methods for generating web page source code:
1. Use of CSS (Cascading Style Sheet) functions to allow for optimized placement of important content near the beginning of web page source code to achieve improved rankings for keywords. Preferably, the sequence of web page source code is de-coupled from the visual rendering of generated web pages (at least herein embodying arranging web-page source code order relating to such at least one plurality of computer-generated web-pages for search-engine-optimizing indexing by such at least one Internet-based indexing program).
2. Use of LSA on static and generated text to determine the most effective keywords to be used for improving search engine indexing results. Preferably, the most effective keywords are used for variable replacement of Merge Variables 223.
3. Use of a single programming source allowing for an unlimited number of web sites based on same programming (at least herein embodying such computer-generating steps for each such web page of such plurality of web pages are performed by exactly one set of computer programming logic). Preferably, each web site is dynamically generated based on web site specific configuration. Preferably, improvements in search engine optimization methods are made available to all Realtor A 102.
4. Use of “nofollow” anchor text attribute, permitted by search engine providers as an HTML attribute, to enhance search engine page ranking of targeted pages. The “nofollow” anchor text attribute can be use to prevent search engine indexing of selected URL's thus improving search engine focus on the most desirable URL's.
5. Use of anchor text re-phrasing by random replacement of contextually appropriate keywords for URL references on web site primary landing pages such as city, community, specialty property, etc. pages, within each generated web site. Preferably anchor text used for the same URL on similar landing pages for different web sites will be different. As shown by Anchor Text 901 on FIG. 7 the contents of Anchor Text 901 vary from one description of the URL to the next. Preferably, Anchor Text 901 used for the same URL's on each generated web site will differ due to random replacement of keywords, thus ensuring uniqueness when viewed by a spider.
6. Use of Merge Variables 223 replacement with relevant keywords in dynamically generated pages.
7. Use of weighted, randomized keyword selection from a Master Keyword Table to minimize and prevent duplicated web pages (at least herein embodying wherein such at least one computer-generated web page, is indexed by such at least one Internet-based-indexing computer program, as unique).
8. Use of programmatically controlled placement of keywords as meta-tags in the web page header on a page-by-page basis. (For example: “<LINK id=“Styles” href=“pageimages/desertwide/styles.css” type=“text/css” rel=“stylesheet”></LINK>”)
9. Automatically creating “removed property detail web pages” for real properties after removal from MLS Copy Database 215 to maintain search engine indexing and to prevent “page not found” messages.
10. Selectively making on web pages for geographic or specialty segments available to users and spiders to improve search engine indexing of available content for Realtor A Web Site 122. Preferably, the robots meta-tag is automatically set to “NOINDEX” if the geographic or specialty segments web page is being generated without any human created content. Preferably, if human created content is present and will be incorporated in the generated web page the robots meta-tag value will not be set to “NOINDEX”. (An example of this usage is “<META NAME=“ROBOTS” CONTENT=“NOINDEX, NOFOLLOW”>”). This method ensures generated web page uniqueness by preventing spiders from indexing web pages containing solely automatically generated content without preventing use of the generated web pages by human users (at least herein embodying preventing indexing, by such at least one Internet-based indexing program, of such at least one computer-generated web page before associating such web-page static content such at least one computer-generated web page; at least herein embodying associating such web-page static content with such at least one computer-generated web page; and at least herein embodying permitting indexing, by such at least one Internet-based indexing program, of such at least one computer-generated web page after associating web-page static content with such at least one computer-generated web page).
11. Use of Back Links 902 (as shown in FIG. 14) on linked to pages that are keyword specific to the keywords used on the calling page used to link to it to further reinforce and concentrate spider indexed weight of the calling (landing) pages.
12. Development of a database querying method that is very efficient, scaleable, and does not use Session ID's to control presentation lengthy lists of query results for real properties within Realtor A Web Site 122.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) An Internet web-based method relating to providing program services, by at least one web-services provider, to at least one plurality of web-site operators of respectively at least one web site each, comprising the steps of:
a) uploading, by such at least one web-services provider, content of at least one database, having information useful to each of such plurality of such web-site operators;
b) receiving, by such at least one web-services provider, web-page content display parameters, relating to such at least one web site, from such at least one web-site operator of such plurality of such web-site operators;
c) computer-generating, on demand, using such received web-page content display parameters, at least one web page containing at least some of such uploaded content for at least one web-site operator of such plurality of such web site operators;
d) computer-generating, on demand, at least one uniform resource locator relating to such at least one web page; and
e) wherein such at least one uniform resource locator comprises at least one web-search term relevant to such at least one web page;
f) computer-generating, on demand, at least one anchor text relating to such at least one uniform resource locator relating to such at least one web page;
g) wherein such at least one anchor text comprises such at least one web-search term relevant to such at least one web page; and
h) wherein such at least one uniform resource locator is indexable by at least one Internet-based-indexing computer program.

2) The Internet web-based method according to claim 1 wherein at least some of such uploaded content represents real properties offered for sale.

3) The Internet web-based method according to claim 2 wherein at least some of such uploaded content represents real properties offered for rent.

4) The Internet web-based method according to claim 1 further comprising the steps of:
a) receiving, by such at least one web-services provider, web-page static content from each of such plurality of such web-site operators;
b) wherein such web-page static content contains at least one replaceable term;
c) creating, by at least one web-services provider, at least one web-search keyword list on behalf of each of such plurality of such web-site operators; and
d) wherein such at least one web-search keyword list comprises such at least one web-search term;
e) replacing, on demand, such at least one replaceable term, with such at least one web-search term;
f) wherein such at least one web-search term is selected from such at least one web-search keyword list.

5) The Internet web-based method according to claim 1 further comprising the step of arranging web-page source code order relating to such at least one plurality of computer-generated web-pages for search-engine-optimizing indexing by such at least one Internet-based indexing program.

6) The Internet web-based method according to claim 1 wherein such computer-generating steps for each such web page of such plurality of web pages are performed by exactly one set of computer programming logic.

7) The Internet web-based method according to claim 6 comprising the steps of:
a) preventing indexing, by such at least one Internet-based indexing program, of such at least one computer-generated web page before associating such web-page static content with such at least one computer-generated web page;
b) associating such web-page static content with such at least one computer-generated web page; and
c) permitting indexing, by such at least one Internet-based indexing program, of such at least one computer-generated web page after associating web-page static content with such at least one computer-generated web page;
d) wherein such at least one computer-generated web page, is indexed by such at least one Internet-based-indexing computer program, as unique.

8) The Internet web-based method according to claim 1 further comprising the steps of:
a) determining, automatically, such content of each such web page of such plurality of web pages to be generated;
b) wherein such determining is based on at least one domain name portion of such at least one uniform resource locator relating to such at least one web page;
c) selecting such at least one web-search term such at least one web-search keyword list;
d) inserting, programmatically, such selected at least one web-search term as at least one meta-tag into each such web page of such plurality of web pages;
e) inserting, programmatically, such selected at least one web-search term into at least one web page heading relating to each such web page of such plurality of web pages;
f) inserting, programmatically, such selected at least one web-search term into at least one page title relating to each such web page of such plurality of web pages; and
g) inserting, programmatically, such selected at least one web-search term as at least one alt tag into each such web page of such plurality of web pages;
h) wherein such selected at least one web-search term is relevant to such content of each such web page of such plurality of web pages; and
i) wherein such at least one web-search term is selected based on its selection frequency.

9) The Internet web-based method according to claim 1 further comprising the steps of:
a) offering such program services to at least one web-site operator of such plurality of web-site operators;
b) performing such program services by such at least one web-services provider on behalf of such at least one web-site operator of such plurality of web-site operators;
c) receiving payment for such program services, by such at least one web-services provider from such at least one web-site operator of such plurality of web-site operators.

10) The Internet web-based method according to claim 1 wherein at least some of such uploaded content represents real properties offered for rent.

11) The Internet web-based method according to claim 1 wherein at least some of such uploaded content represents real properties offered exclusively.

12) The Internet web-based method according to claim 1 wherein at least some of such web-page content display parameters are useable to define a hierarchy of themed content.

13) The Internet web-based method according to claim 12 wherein such hierarchy of themed content comprises a hierarchy of categories of real estate listings.

14) The Internet web-based method according to claim 1 further comprising the steps of:
a) in exchange for a received link, providing a link for a web page associated with a particular one of such at least one web site;
b) wherein such provided link is different from a previously provided link for the same web site.

15) The Internet web-based method according to claim 14 wherein such provided link is provided randomly from a list of links.

16) The Internet web-based method according to claim 14 wherein such provided link is provided according to an assigned selection weighting.

17) The Internet web-based method according to claim 14 further comprising the step of:
a) providing text information along with such provided link;
b) wherein such provided text information is different from previously provided text information.

18) A computer program system, relating to computer generation of at least one plurality of web pages within at least one plurality of web sites on behalf of at least one plurality of web-site operators comprising:
a) at least one first computer processor adapted to receive data-based information useful to each of such plurality of such web-site operators;
b) at least one first computer database storage adapted to store such received data-based information in at least one first database;
c) at least one first computer interface adapted to receive web-page-content display parameters, relating to such at least one web site of such plurality of such web sites;
d) at least one second computer database adapted to store such received web-page-content display parameters in at least one second database;
e) at least one second computer processor adapted to generate, on demand, using such received web-page-content display parameters, at least one web page containing at least some of such received data-based information;
f) at least one third computer processor adapted to generate, on demand, at least one least one uniform resource locator relating to such at least one web page;
g) wherein such at least one uniform resource locator comprises at least one first web-search term relevant to such received data-based information; and
h) at least one fourth computer processor adapted to generate, on demand, at least one anchor text relating to such at least one uniform resource locator relating to such at least one web page;
i) wherein such at least one anchor text comprises such at least one web-search term relevant to such at least one web page; and
j) wherein such at least one uniform resource locator is indexable by at least one Internet-based-indexing program.

19) The computer program system according to claim 18 wherein at least some of such received data-based information represents real properties offered for sale.

20) The computer program system according to claim 19 wherein at least some of such received data-based information represents real properties offered for rent.

21) The computer program system according to claim 18 further comprising:
a) at least one second computer interface adapted to for receive web-page static content from at least one web-site operator of such plurality of such web-site operators;
b) wherein such web-page static content contains at least one replaceable term;
c) third computer interface adapted to receive at least one specific web-search keyword list on behalf of each of such plurality of such web-site operators;
d) wherein such web-search keyword list comprises at least one web-search term;
e) at least one fifth computer processor adapted to replace, on demand, such at least one replaceable term, with such at least one web-search term; and
f) wherein such at least one web-search term is selected from such at least one web-search keyword list.

22) The computer program system according to claim 18 further comprising:
a) at least one sixth computer processor adapted to determine, automatically, such content of each such web page of such plurality of web pages to be generated;
b) wherein such determining is based on at least one domain name portion of such at least one uniform resource locator relating to such at least one web page;
c) at least one seventh computer processor adapted to select such at least one web-search term from such at least one web-search keyword list;
d) at least one eighth computer processor adapted to insert, automatically, such selected at least one web-search term as at least one meta-tag into each such web page of such plurality of web pages;
e) at least one ninth computer processor adapted to insert, programmatically, such selected at least one web-search term into at least one web page heading relating to each such web page of such plurality of web pages;
f) at least one tenth computer processor adapted to insert, programmatically, such selected at least one web-search term into at least one page title relating to each such web page of such plurality of web pages; and
g) at least one eleventh computer processor adapted to insert, programmatically, such selected at least one web-search term as at least one alt tag into each such web page of such plurality of web pages;
h) wherein such selected at least one web-search term is relevant to such content of each such web page of such plurality of web pages; and
i) wherein such at least one web-search term is selected based on its selection frequency.
j)

23) The computer program system according to claim 18 further comprising:
a) at least one twelfth computer processor adapted to prevent indexing, by such at least one Internet-based indexing program, of such at least one computer-generated web page before associating such web-page static content such at least one computer-generated web page;
b) at least one thirteenth computer processor adapted to associate such web-page static content with such at least one computer-generated web page; and
c) at least one fourteenth computer processor adapted to permit indexing, by such at least one Internet-based indexing program, of such at least one computer-generated web page after associating web-page static content with such at least one computer-generated web page;
d) wherein such at least one computer-generated web page, is indexed by such at least one Internet-based-indexing computer program, as unique.

24) The computer program system according to claim 18 wherein at least some of such received data-based information represents real properties offered for rent.

25) The computer program system according to claim 18 further comprising:
a) at least one fifteenth computer processor adapted to provide, for a received link, a web page associated with a particular one of such plurality of web sites;
b) wherein such provided link is different from a previously provided link for the same web site.

26) The computer program system according to claim 25 wherein such provided link is provided randomly from a list of links.

27) The computer program system according to claim 25 wherein such provided link is provided according to an assigned selection weighting.

28) The computer program system according to claim 25 further comprising:
a) at least one sixteenth computer processor adapted to provide text information along with such provided link;
b) wherein such provided text information is different from previously provided text information.

29) A computer system, relating to automated generation of at least one uniform resource locator, relating to at least one data record stored in at least one database, on behalf of at least one web-site operator of at least one plurality of web-site operators comprising:
a) at least one first computer processor adapted to receive at least one data record comprising information useful to at least one of such plurality of such web-site operators;
b) at least one first database adapted to store such at least one received data record in at least one database;
c) at least one first computer interface adapted to receive at least one web-site operator specific web-search keyword list;
d) wherein such at least one web-site operator specific web-search keyword list comprises at least one web-search term;
e) at least one second computer processor adapted to substantially automatically construct at least one uniform resource locator, referring to at least one web page for displaying such at least one stored data record;
f) wherein such constructed at least one uniform resource locator comprises at least one randomly selected web-search term relating to each such at least one web page;
g) at least one third computer processor adapted to substantially automatically construct at least one anchor text relating to such constructed at least one uniform resource locator relating to such at least one web page;
h) wherein such at least one anchor text comprises such at least one web-search term relevant to such at least one web page; and
i) wherein such at least one uniform resource locator is indexable by at least one Internet-based-indexing computer program.

30) The computer system according to claim 29 further comprising:
a) at least one fourth computer processor adapted to receive at least one web-page request based on such at least one constructed uniform resource locator; and
b) at least one fifth computer processor adapted to generate at least one set of web-page source code, relating to such at least one received uniform resource locator, usable by at least one web browser for displaying such at least one web page having at least one data record retrieved from at least one data base;
c) wherein such at least one set of web-page source code order is arranged for search-engine-optimizing indexing by such at least one Internet-based indexing program.

31) The computer system according to claim 29 further comprising:
a) at least one second computer interface adapted to receive web-page content display parameters;
b) at least one second database adapted to store such web-page content display parameters, relating to each such at least one web site, from each of such plurality of such web-site operators;
c) at least one second computer interface adapted to receive web-page static content from such at least one web-site operator;
d) at least one third database adapted to store such web-page static content in at least one database;
e) wherein such web-page static content contains at least one replaceable term;
f) at least one sixth computer processor adapted to replace, on demand, such at least one replaceable term, with such at least one web-search term;
g) wherein such at least one web-search term is randomly selected from such at least one web-site operator specific keyword list; and
h) at least one seventh computer processor adapted to generate at least one set of source code, related to such at least one received uniform resource locator, usable by at least one web browser for displaying at least one web page having at least some static content retrieved from at least one data base.

32) A computer system, relating to automatic generation of at least one static uniform resource locator referencing at least one dynamic web page on behalf of at least one web-site operator comprising:
a) at least one first computer processor adapted to receive dynamic web-page content useful to such at least one web-site operator;
b) at least one first database adapted to store such received dynamic web-page content in at least one first database;
c) at least one second computer processor adapted to select at least some dynamic web-page content;
d) at least one third computer processor adapted to select at least one keyword relating to such selected at least some dynamic web-page content; and
e) at least one fourth computer processor adapted to construct such at least one static uniform resource locator referencing such selected at least some dynamic web-page content; and
f) wherein such constructed at least one static uniform resource locator comprises such at least one keyword relating to such selected at least some dynamic web-page content; and
g) wherein such constructed at least one static uniform resource locator contains at least one database search argument relating to selecting such selected at least some dynamic web-page content from such at least one first database;
h) at least one fifth computer processor adapted to construct at least one anchor text relating to such constructed at least one static uniform resource locator;
i) wherein such at least one anchor text comprises such at least one keyword relating to such selected at least some dynamic web-page content; and
j) wherein such constructed at least one static uniform resource locator is indexable by at least one Internet-based-indexing program.

33) The computer system according to claim 32 wherein such second computer processor adapted to select at least some dynamic web-page content comprises:
a) at least one sixth computer processor adapted to receive web-page-content display parameters for such at least one web site from such at least one web-site operator;
b) at least one second database adapted to store such received web-page-content display parameters in at least one second database;
c) at least one seventh computer processor adapted to receive keywords related to such at least one web site on behalf of such at least one web-site operator;
d) at least one third database adapted to store such received keywords in at least one third database; and
e) at least one eighth computer processor adapted to select, using such stored display parameters, such at least some dynamic web-page content.
f)

34) The computer system according to claim 32 further comprising
a) at least one ninth computer processor adapted to receive at least one dynamic web-page request, using such constructed at least one static uniform resource locator, for such selected dynamic web-page content; and
b) at least one tenth computer processor adapted generate requested such at least one dynamic web-page from such selected at least some web-page content.

35) A method relating to search engine optimization relating to computer generation of at least one plurality of dynamic web pages within at least one plurality of web sites on behalf of at least one plurality of web-site operators comprising the steps of:
a) identifying web-content indexing methods of web-content indexing entities;
b) adapting web site computer generation methods to optimize web-content indexing results for such computer generated web pages within such at least one plurality of web sites;
c) computer generating at least one static uniform resource locator referencing such at least one dynamic web page of such plurality of dynamic web pages;
d) wherein such at least one static uniform resource locator comprises at least one database query argument for selecting at least some dynamic content;
e) wherein such at least one static uniform resource locator comprises at least one indexable keyword relating to such selected dynamic content;
f) computer generating such at least one dynamic web page;
g) wherein such at least one dynamic web page comprises such selected dynamic content;
h) wherein such at least one dynamic web page comprises static content;
i) wherein such static content contains at least one replaceable term;
j) identifying at least one plurality of keywords using latent semantic analysis of such static content;
k) selecting, at least on keyword of such identified plurality of keywords;
l) replacing such at least one replaceable term with selected such at least one keyword;
m) re-phrasing at least one anchor text referring to such at least one static uniform resource locator on selected such at least one dynamic web page using such at least one keyword;
i) wherein such at least one keyword is relevant to such dynamic content, and
ii) wherein such at least one keyword is relevant to such static content;
n) arranging source code relating to generated such at least one dynamic web page for search-engine-optimizing indexing by such at least one Internet-based indexing program;
o) inserting, programmatically, at least one meta-tag into generated such at least one dynamic web page;
i) wherein such at least one meta-tag comprises at least one keyword,
ii) wherein such at least one keyword is relevant to such dynamic content of generated such at least one dynamic web page,
iii) wherein such at least one keyword is relevant to such static content of generated such at least one dynamic web page;
p) inserting, programmatically, at least one web-page heading into generated such at least one dynamic web page;
i) wherein such at least one web-page heading comprises at least one keyword,
ii) wherein such at least one keyword is relevant to such dynamic content of generated such at least one dynamic web page,
iii) wherein such at least one keyword is relevant to such static content of generated such at least one dynamic web page;
q) inserting, programmatically, at least one web-page title into generated such at least one dynamic web page;
i) wherein such at least one web-page title comprises at least one keyword,
ii) wherein such at least one keyword is relevant to such dynamic content of generated such at least one dynamic web page,
iii) wherein such at least one keyword is relevant to such static content of generated such at least one dynamic web page;
r) inserting, programmatically, at least one alt tag into generated such at least one dynamic web page;
i) wherein such at least one web-page title comprises at least one keyword,
ii) wherein such at least one keyword is relevant to such dynamic content of generated such at least one dynamic web page,
iii) wherein such at least one keyword is relevant to such static content of generated such at least one dynamic web page;
s) preventing indexing, by such at least one Internet-based indexing program, of such at least one dynamic web page before associating descriptive content provided by such at least one web-site operator with such at least one static uniform resource locator referencing such at least one dynamic web page;
t) associating such descriptive content provided by such at least one web-site operator with such at least one static uniform resource locator referencing such at least one dynamic web page; and
u) permitting indexing, by such at least one Internet-based indexing program, of such at least one dynamic web page after associating descriptive content provided by such at least one web-site operator with such at least one static uniform resource locator referencing such at least one dynamic web page.

36) An Internet web-based method relating to providing program services, by at least one web-services provider, to at least one plurality of web-site operators of respectively at least one web site each, comprising the steps of:
a) uploading, by such at least one web-services provider, content of at least one database, having information useful to each of such plurality of such web-site operators;
b) receiving, by such at least one web-services provider, web-page content display parameters, relating to such at least one web site, from such at least one web-site operator of such plurality of such web-site operators;
c) computer-generating, on demand, using such received web-page content display parameters, at least one web page containing at least some of such uploaded content for at least one web-site operator of such plurality of such web site operators;
d) computer-generating, on demand, at least one uniform resource locator relating to such at least one web page; and
e) wherein such at least one uniform resource locator comprises at least one web-search term relevant to such at least one web page;
f) wherein such at least one uniform resource locator is indexable by at least one Internet-based-indexing computer program.

37) A computer system, relating to computer generation of at least one plurality of web pages within at least one plurality of web sites on behalf of at least one plurality of web-site operators comprising:
a) at least one first computer processor adapted to receive data-based information useful to each of such plurality of such web-site operators;
b) at least one first computer database adapted to store such received data-based information in at least one first database;
c) at least one first computer interface adapted to receive web-page-content display parameters, relating to such at least one web site of such plurality of such web sites;
d) at least one second computer database adapted to store such received web-page-content display parameters in at least one second database;
e) at least one second computer processor adapted to generate, on demand, using such received web-page-content display parameters, at least one web page containing at least some of such received data-based information;
f) at least one third computer processor adapted to generate, on demand, at least one least one uniform resource locator relating to such at least one web page;
g) wherein such at least one uniform resource locator comprises at least one first web-search term relevant to such received data-based information; and
h) wherein such at least one uniform resource locator is indexable by at least one Internet-based-indexing program.
